(19) United States
(12) Patent Application Publication
(10) Pub. No.: US 2026/0046720 A1
(43) Pub. Date: Feb. 12, 2026

(54) NON-TERRESTRIAL NETWORK-TERRESTRIAL NETWORK INTERWORKING

(71) Applicant: InterDigital Patent Holdings, Inc., Wilmington, DE (US)

(72) Inventors: Brian Martin, Farnham (GB); Dylan Watts, Montreal (CA); Oumer Teyeb, Montreal (CA); Moon-il Lee, Melville, NY (US)

(73) Assignee: InterDigital Patent Holdings, Inc., Wilmington, DE (US)

(21) Appl. No.: 19/101,398

(22) PCT Filed: Aug. 4, 2023
(86) PCT No.: PCT/US2023/029474

§ 371 Date: Feb. 5, 2025

Related U.S. Application Data
(60) Provisional application No. 63/395,387, filed on Aug. 5, 2022.

(51) Int. Cl. H04W 36/08; H04B 17/318; H04W 36/00; H04W 68/02; H04W 76/20; H04W 76/30; H04W 84/06

(52) U.S. Cl. CPC H04W 36/08; H04B 17/328; H04W 36/0058; H04W 68/02; H04W 76/20; H04W 76/30; H04W 84/06

(57) ABSTRACT

A wireless transmit-receive unit (WTRU) may camp on a non-terrestrial network (NTN) cell and evaluate one or more terrestrial network (TN) cells, for example, to determine whether to change a radio access network (RAN) based notification area (RNA). In examples, the WTRU may receive an indication to change from a first TN cell to the NTN cell. The WTRU may perform, based on the indication, a cell reselection to the NTN cell. The first TN cell may be associated with a first RNA. The WTRU may evaluate a second TN cell associated with a second RNA. The WTRU may determine that a cell reselection condition associated with the second TN cell is satisfied. The WTRU may perform, based on the determination that the cell reselection condition is satisfied, a cell reselection to the second TN cell.

### CROSS-REFERENCE TO RELATED APPLICATIONS

This application claims the benefit of provisional U.S. patent application Ser. No. 63/395,387, filed Aug. 5, 2022, the disclosure of which is incorporated herein by reference in its entirety.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth-generation (4G) long-term evolution (LTE). Wireless communication devices may establish communications with other devices and data networks, e.g., via an access network, such as a radio access network (RAN).

### SUMMARY

Systems, methods, and instrumentalities are disclosed herein for non-terrestrial network (NTN)-terrestrial network (TN) interworking.

A wireless transmit-receive unit (WTRU) may camp on an NTN cell and evaluate one or more TN cells, for example, to determine whether to change a radio access network (RAN) based notification area (RNA). In examples, the WTRU may receive an indication to change from a first TN cell to the NTN cell. The WTRU may perform, based on the indication, a cell reselection to the NTN cell. The first TN cell may be associated with a first RNA. The WTRU may evaluate a second TN cell associated with a second RNA. The WTRU may determine that a cell reselection condition associated with the second TN cell is satisfied. The WTRU may perform, based on the determination that the cell reselection condition is satisfied, a cell reselection to the second TN cell. For example, the evaluation of the second TN cell associated with the second RNA may include a measurement of the second TN cell associated with the second RNA and/or the determination that the cell reselection condition associated with the second TN cell is satisfied.

The WTRU may evaluate the second TN cell during a time period associated with the WTRU being configured to monitor, for example, in an RRC_INACTIVE state, for a paging message from the NTN cell. In examples, the WTRU may receive an indication to change a state of the WTRU from an RRC_CONNECTED state to an RRC_INACTIVE state. The WTRU may initiate the change from the RRC_CONNECTED state to the RRC_INACTIVE state based on the indication. The WTRU may monitor, in the RRC_INACTIVE state (e.g., during a time period associated with the WTRU being configured to operate in the RRC_INACTIVE state), for the paging message from the NTN cell. The WTRU may evaluate the second TN cell when the WTRU monitors for the paging message from the NTN cell. If the cell reselection condition associated with the second TN cell is satisfied, the WTRU may perform the cell reselection to the second TN cell associated with the second RNA. The WTRU may receive, in the RRC_INACTIVE state, the paging message from the NTN cell. The WTRU may initiate a change of the state of the WTRU from the RRC_INACTIVE state to the RRC_CONNECTED state based on the reception of the paging message. The WTRU may receive, in the RRC_CONNECTED state (e.g., during a time period associated with the WTRU being configured to operate in the RRC_CONNECTED state), a data transmission from the second TN cell associated with the second RNA.

In examples, the WTRU may send, to the NTN cell, an indication of a change from the first RNA to the second RNA. The WTRU may receive an indication, from the NTN cell, to change the state of the WTRU from an RRC_INACTIVE state to an RRC_IDLE state. The WTRU may initiate, based on the indication, a change from the RRC_INACTIVE state to the RRC_IDLE state, for example, before the cell reselection to the second TN cell is performed.

The WTRU may evaluate one or more TN cells, for example, based on identification information associated with the one or more TN cells. The WTRU may receive the identification information associated with the one or more TN cells, which may include the first TN cell associated with the first RNA and/or the second TN cell associated with the second RNA. The WTRU may evaluate, based on the identification information, the one or more TN cells for a cell reselection. The WTRU may evaluate the one or more TN cells during a time period associated with the WTRU being configured to monitor for the paging message from the NTN cell. In examples, the WTRU may limit the evaluation to the one or more TN cells (e.g., without evaluating the NTN cell for the cell reselection).

The WTRU may determine the satisfaction of the cell reselection condition associated with the second TN cell based on a reference signal received power (RSRP) associated with the second TN cell. The WTRU may receive a cell reselection threshold in a radio resource control (RRC) message. The WTRU may determine the RSRP associated with the second TN cell associated with the second RNA. To determine the satisfaction of the cell reselection condition associated with the second TN cell, the WTRU may determine that the RSRP associated with the second TN cell is equal to or greater than the cell reselection threshold.

The WTRU may determine the satisfaction of the cell reselection condition associated with the second TN cell based on the cell reselection priority associated with the second TN cell. The WTRU may receive, in a RRC message, cell reselection priority information. The WTRU may determine the cell reselection priority associated with the second TN cell associated with the second RNA. The WTRU may determine the satisfaction of the cell reselection condition associated with the second TN cell based on the cell reselection priority associated with the second TN cell and the cell reselection priority information received in the RRC message.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is an example of a depiction of the different interfaces in a non-terrestrial network.

FIG. 3 is an example of a WTRU triggered transition from RRC_IDLE to RRC_CONNECTED.

FIG. 4 is an example of a rejection of a WTRU triggered transition from RRC_IDLE.

FIG. 5 is an example of a WTRU triggered transition from RRC_INACTIVE to RRC_CONNECTED (WTRU context retrieval success).

FIG. 6 is an example of a WTRU triggered transition from RRC_INACTIVE to RRC_CONNECTED (WTRU context retrieval failure).

FIG. 7 is an example of a rejection from the network when a WTRU attempts to resume a connection.

FIG. 8 is an example of a network triggered transition from RRC_INACTIVE to RRC_CONNECTED.

FIG. 9 is an example of a RNA update procedure with WTRU context relocation.

FIG. 10 is an example of a periodic RNA update procedure without WTRU context relocation.

FIG. 11 is an example of a RNA update procedure with a transition to RRC_IDLE.

FIG. 12 is an example of a resume request responded with release with redirect, with WTRU context relocation.

FIG. 13 is an example procedure for CN controlled subgrouping.

FIG. 14 is an example procedure for WTRU ID based subgrouping.

FIG. 15 is an example of NTN-TN network layers.

FIG. 16 is an example of release to RRC_IDLE for camping on an NTN.

FIG. 17 is an example of a RNA change based on TN measurements.

FIG. 18 is an example of a RNA change based on TN measurements.

FIG. 19 is an example 1900 for evaluation of one or more TN cells to determine a RNA update.

### DETAILED DESCRIPTION

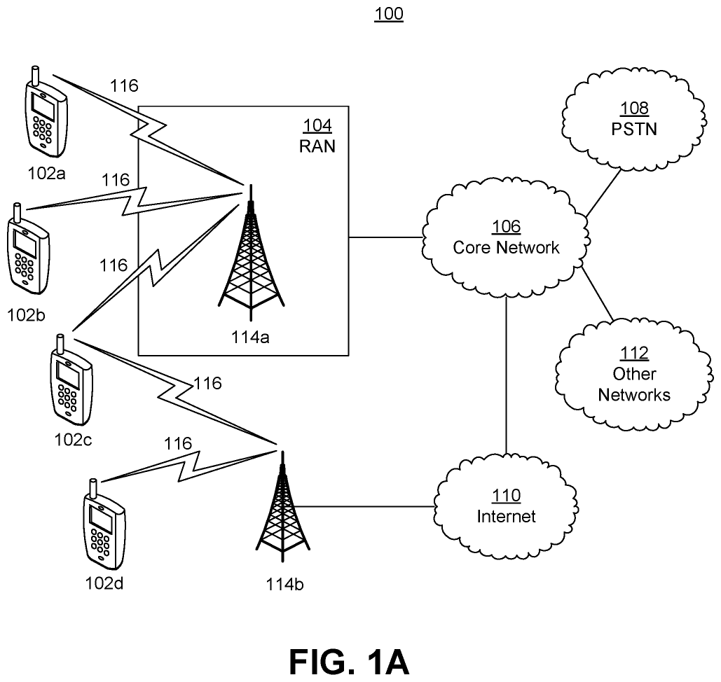

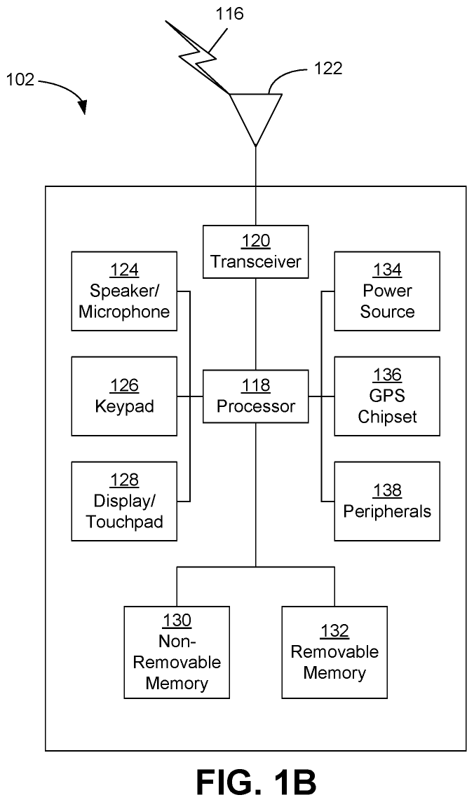

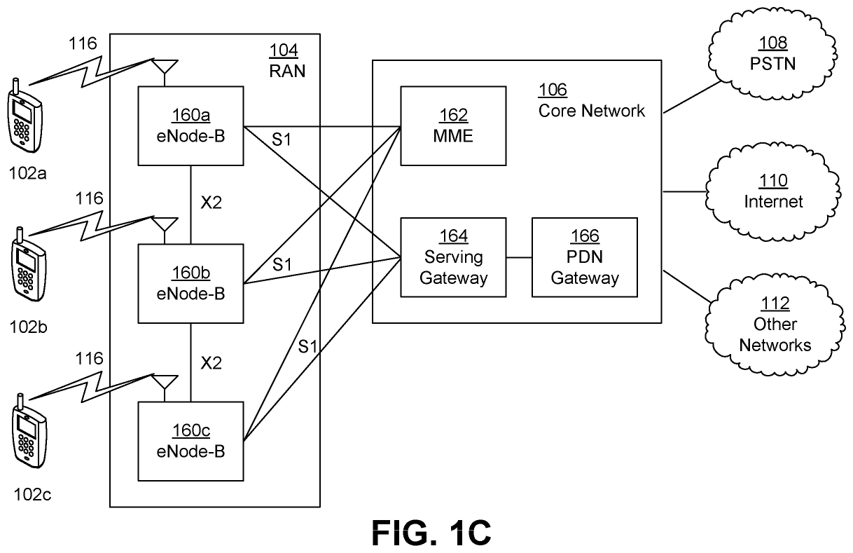

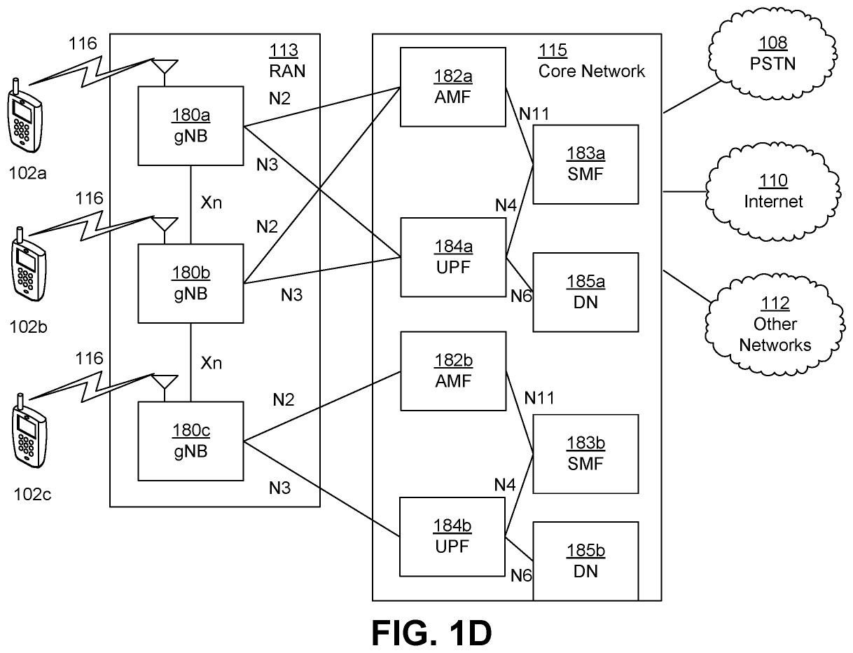

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an encode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160cmay each include one or more transceivers for communicating with the WTRUs 102a, 102b, 102c over the air interface 116. In one embodiment, the eNode-Bs 160a, 160b, 160cmay implement MIMO technology. Thus, the eNode-B 160a,for example, may use multiple antennas to transmit wireless signals to, and/or receive wireless signals from, the WTRU 102a.

Each of the eNode-Bs 160a, 160b, 160cmay be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 160a, 160b, 160cin the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80×80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80×80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTls) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160csubstantially simultaneously. In the non-standalone configuration, eNode-Bs 160a, 160b, 160cmay serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU (e.g., the WTRU in an RRC_INACTIVE state or an RRC_CONNECTED state) on a TN may send an indication of a preference to camp on a non-terrestrial network (NTN), for example, to the TN. The TN may release the WTRU to an RRC_IDLE state. The WTRU may perform a cell reselection to camp on the NTN and/or monitor for paging from the NTN.

For example, a WTRU may transmit an indication of an availability of an NTN, for example, in a message. The WTRU may receive an RRC release message from a TN. The WTRU may transition to an RRC idle operation condition from an RRC inactive operating condition based on the RRC release message received from the TN. The WTRU may camp on the NTN and attempt to decode a paging message from the NTN. The message that comprises the indication of the availability of the NTN may include WTRU assistance information (e.g., UE assistance information) and/or an RRC release request.

A WTRU may camp on an NTN in an RRC_INACTIVE state and monitor for a change in a RNA on a TN using, for example, neighbour cell measurements and/or cell reselection evaluation. The WTRU may perform an RAN notification area update if a change in the TN RNA is detected, for example, via the current NTN, or by triggering a cell reselection to the TN.

For example, a WTRU may operate in an RRC inactive operating condition. The WTRU may camp on an NTN, for example, while operating in the RRC inactive operating condition. The WTRU may detect a change in a RNA associated with a TN and perform a RNA update based on the detected change in the RNA associated with the TN. The WTRU may detect the change of the RNA associated with the TN based on a cell selection criterion. The WTRU may measure a plurality of TN cells that are neighbors to a TN cell associated with the RNA, while camping on the NTN. The WTRU may determine that a cell reselection criterion is met based on the measurement of the plurality of TN cells and detect the change of the RNA associated with the TN based on the determination that the cell selection criteria is met. The WTRU may perform the RNA update via the NTN network or by triggering a cell reselection to the TN.

Systems, methods, and instrumentalities are disclosed herein for NTN-TN interworking. A WTRU may camp on an NTN cell and evaluate one or more TN cells, for example, to determine whether to change a RNA. In examples, a WTRU may camp on an NTN cell and evaluate one or more TN cells, for example, to determine whether to change a RNA. In examples, the WTRU may receive an indication to change from a first TN cell to the NTN cell. The WTRU may perform, based on the indication, a cell reselection to the NTN cell. The first TN cell may be associated with a first RNA. The WTRU may evaluate a second TN cell associated with a second RNA. The WTRU may determine that a cell reselection condition associated with the second TN cell is satisfied. The WTRU may perform, based on the determination that the cell reselection condition is satisfied, a cell reselection to the second TN cell. For example, the evaluation of the second TN cell associated with the second RNA may include a measurement of the second TN cell associated with the second RNA and/or the determination that the cell reselection condition associated with the second TN cell is satisfied.

The WTRU may evaluate the second TN cell during a time period associated with the WTRU being configured to monitor, for example, in an RRC_INACTIVE state, for a paging message from the NTN cell. In examples, the WTRU may receive an indication to change a state of the WTRU from an RRC_CONNECTED state to an RRC_INACTIVE state. The WTRU may initiate the change from the RRC_CONNECTED state to the RRC_INACTIVE state based on the indication. The WTRU may monitor, in the RRC_INACTIVE state (e.g., during a time period associated with the WTRU being configured to operate in the RRC_INACTIVE state), for the paging message from the NTN cell. The WTRU may evaluate the second TN cell when the WTRU monitors for the paging message from the NTN cell. If the cell reselection condition associated with the second TN cell is satisfied, the WTRU may perform the cell reselection to the second TN cell associated with the second RNA. The WTRU may receive, in the RRC_INACTIVE state, the paging message from the NTN cell. The WTRU may initiate a change of the state of the WTRU from the RRC_INACTIVE state to the RRC_CONNECTED state based on the reception of the paging message. The WTRU may receive, in the RRC_CONNECTED state (e.g., during a time period associated with the WTRU being configured to operate in the RRC_CONNECTED state), a data transmission from the second TN cell associated with the second RNA.

In examples, the WTRU may send, to the NTN cell, an indication of a change from the first RNA to the second RNA. The WTRU may receive an indication, from the NTN cell, to change the state of the WTRU from an RRC_INACTIVE state to an RRC_IDLE state. The WTRU may initiate, based on the indication, a change from the RRC_INACTIVE state to the RRC_IDLE state, for example, before the cell reselection to the second TN cell is performed.

The WTRU may evaluate one or more TN cells, for example, based on identification information associated with the one or more TN cells. The WTRU may receive the identification information associated with the one or more TN cells, which may include the first TN cell associated with the first RNA and/or the second TN cell associated with the second RNA. The WTRU may evaluate, based on the identification information, the one or more TN cells for a cell reselection. The WTRU may evaluate the one or more TN cells during a time period associated with the WTRU being configured to monitor for the paging message from the NTN cell. In examples, the WTRU may limit the evaluation to the one or more TN cells (e.g., without evaluating the NTN cell for the cell reselection).

The WTRU may determine the satisfaction of the cell reselection condition associated with the second TN cell based on a reference signal received power (RSRP) associated with the second TN cell. The WTRU may receive a cell reselection threshold in a radio resource control (RRC) message. The WTRU may determine the RSRP associated with the second TN cell associated with the second RNA. To determine the satisfaction of the cell reselection condition associated with the second TN cell, the WTRU may determine that the RSRP associated with the second TN cell is equal to or greater than the cell reselection threshold.

The WTRU may determine the satisfaction of the cell reselection condition associated with the second TN cell based on the cell reselection priority associated with the second TN cell. The WTRU may receive, in a RRC message, cell reselection priority information. The WTRU may determine the cell reselection priority associated with the second TN cell associated with the second RNA. The WTRU may determine the satisfaction of the cell reselection condition associated with the second TN cell based on the cell reselection priority associated with the second TN cell and the cell reselection priority information received in the RRC message.

NTN(s) may be implemented in one or more examples herein.

NTN(s) may facilitate deployment of wireless networks in areas where land-based antennas may be impractical, for example, due to geography and/or costs. It may be envisioned that, coupled with terrestrial networks, NTN may enable the ubiquitous coverage of 5G networks. NTN deployments may support basic talk and/or text anywhere in the world and, if coupled with the proliferation of next-generation low-orbit satellites, may enable enhanced services (e.g., web browsing).

A basic NTN may include a platform (e.g., an aerial or space-borne platform), which, via a gateway (GW), transports signals from a land-based base station (e.g., a gNB) to a WTRU and vice-versa. NTN(s) may support power class 3 WTRU with omnidirectional antenna and linear polarization, and/or a very small aperture antenna (VSAT) terminal with directive antenna and circular polarization. Support for narrow-band Internet of Things (NB-IoT) and enhanced MTC (eMTC) type devices may be provided. Regardless of device type(s), it may be assumed that one or more (e.g., all) NTN WTRUs may be global navigation satellite system (GNSS) capable.

The platforms (e.g., aerial or space-borne platforms) may be classified in terms of orbit, for example, focusing on low-earth orbit (LEO) satellites with an altitude range of 300-1500 km and geostationary earth orbit (GEO) satellites with an altitude at 35 786 km. Other platform classifications (e.g., medium-earth orbit (MEO) satellites with an altitude range 7000-25000 km and high-altitude platform stations (HAPS) with an altitude of 8-50 km) may be assumed to be implicitly supported. Satellite platforms may be further classified as having a “transparent” or “regenerative” payload. Transparent satellite payloads may implement a frequency conversion and a RF amplification in the uplink and downlink, for example, with multiple transparent satellites possibly connected to one land-based gNB. Regenerative satellite payloads may implement a full gNB or gNB distributed unit (DU) onboard the satellite. Regenerative payloads may perform digital processing on the signal including, for example, one or more of the following: demodulation; decoding; re-encoding; re-modulation; filtering. References herein to a gNB may refer to an example base station and the gNB may be substituted with any other suitable base station.

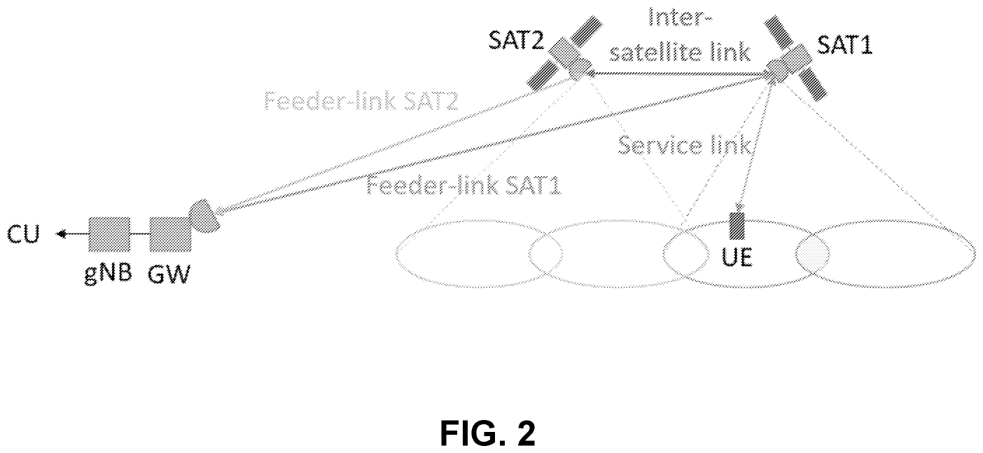

The following radio interfaces may be defined in NTN: feeder-link (e.g., a wireless link between the GW and satellite; service link (e.g., a radio link between the satellite and a WTRU); inter-satellite Link (ISL) (e.g., a transport link between satellites). The ISL may be supported by (e.g., only by) regenerative payloads and may be a 3GPP radio or proprietary optical interface. FIG. 2 is an example depicting different interfaces in a non-terrestrial network. The WTRU in one or more examples (e.g., the examples shown in one or more figures herein) may be interchangeably referred to as a UE.

Depending on a satellite payload configuration, a different interface (e.g., a different 3GPP interface) may be used for a (e.g., each) radio link. In a transparent payload, the NR-Uu radio interface may be used for the service link and/or the feeder-link. For a regenerative payload, the NR-Uu interface may be used for the service link, and a satellite radio interface (SRI) may be used for the feeder-link. A user plane (UP)/control plane (CP) protocol stack for a (e.g., each) payload configuration may be used.

An NTN satellite may support multiple cells, a (e.g., each) cell of which may include one or more satellite beams. The one or more satellite beams may cover a footprint on earth (e.g., in a way in which a terrestrial cell covers a footprint on earth) and may range in diameter from 100 km to 1000 km in LEO deployments, and 200-3500 km diameter in GEO deployments. Beam footprints in GEO deployments may remain fixed relative to earth, and, in LEO deployments, the area covered by a beam/cell may change over time, for example, due to satellite movement(s). The beam movement(s) may be classified as “earth moving”, where the LEO beam moves continuously across the earth, or as “earth fixed”, where the beam may be steered to remain covering a fixed location until a different cell (e.g., a new cell) overtakes the coverage area (e.g., in a discrete and coordinated change).

Due to the altitude of NTN platform(s) and/or the beam diameter, the round-trip time (RTT) and maximum differential delay associated with NTN may be larger (e.g., significantly larger) than those of terrestrial systems. In a transparent NTN deployment, a RTT may range from 25.77 ms (e.g., for LEO@600 km altitude) to 541.46 ms (e.g., for GEO) and the maximum differential delay may be from 3.12 ms to 10.3 ms. The RTT of a regenerative payload may be approximately half that of a transparent payload, as, in some examples, a transparent configuration may include the service link and the feeder link, whereas the RTT of a regenerative payload may consider the service link (e.g., the service link only). To minimize the impact(s) on some NR systems (e.g., to avoid a preamble ambiguity or to properly time reception window(s)), a WTRU may perform a timing pre-compensation prior to an initial access.

A pre-compensation procedure may require the WTRU to obtain one or more of the following: the WTRU's position (e.g., via GNSS); the feeder-link delay and/or the common delay (e.g., via satellite ephemeris data); a satellite position (e.g., via satellite ephemeris data). The satellite ephemeris data may be broadcast (e.g., periodically broadcast) in system information, and may contain one or more of the following: the satellite speed; direction; velocity. The WTRU may estimate the distance and/or delay from the satellite, and/or may add a feeder-link delay component to obtain a full WTRU-gNB RTT (e.g., UE-gNB RTT), which may be n used to offset one or more of the following: timer(s); reception window(s); or timing relation(s). It may be assumed that a frequency compensation may be performed, for example, by the network.

WTRU mobility and/or measurement reporting may be provided in NTN. In NTN, the difference in RSRP between a cell center and a cell edge may not be as pronounced as in terrestrial systems. This, coupled with a relatively larger region of cell overlap may, in some examples, result in a reduced reliability of some measurement-based mobilities (e.g., traditional measurement-based mobility) in an NTN environment. Different conditional handover and measurement reporting triggers associated with location and/or time (e.g., different triggers relying on location and/or time) may be provided. Enhanced mobility may be used in some examples (e.g., LEO deployments) where, due to a satellite movement, a stationary WTRU may be expected to perform mobility periodically (e.g., approximately every 7 seconds depending on deployment characteristics).

Mobility, state transition, and paging may be described herein. Mobility in RRC_IDLE may be described herein. Cell Selection may be described herein.

The principles of public land mobile network (PLMN) selection in NR may be based on PLMN selection principles. Cell selection may be required on transition from RM-DEREGISTERED to RM-REGISTERED, from CM-IDLE to CM-CONNECTED and from CM-CONNECTED to CM-IDLE and may be based on one or more of the following principles: the WTRU Non-Access-Stratum (NAS) layer may identify a selected PLMN and equivalent PLMNs; cell selection may be based on cell-defining synchronization signal blocks (CD-SSBs) located on the synchronization raster (see clause 5.2.4) (e.g., the WTRU may search the NR frequency bands and for a (e.g., each) carrier frequency may identify the strongest cell as per the CD-SSB. It may then read cell system information broadcast to identify its PLMN(s) (e.g., the WTRU may search a (e.g., each) carrier in turn (“initial cell selection”) or make use of stored information to shorten the search (“stored information cell selection”)); the WTRU may seek to identify a suitable cell (if it may not be able to identify a suitable cell it may seek to identify an acceptable cell). When a suitable cell may be found or if an acceptable cell (e.g., only an acceptable cell is found), it may camp on that cell and commence the cell reselection procedure (e.g., a suitable cell may be one for which the measured cell attributes satisfy the cell selection criteria; the cell PLMN may be the selected PLMN, registered or an equivalent PLMN; the cell may not be barred or reserved and the cell may not be part of a tracking area which may be in the list of “forbidden tracking areas for roaming”; an acceptable cell may be one for which the measured cell attributes satisfy the cell selection criteria and the cell may not be barred); the IAB-MT may apply the cell selection procedure as described for the WTRU with the following differences (e.g., the IAB-MT may ignore cell-barring or cell-reservation indications contained in cell system information broadcast; the IAB-MT may consider (e.g., only consider) a cell as a candidate for cell selection if the cell system information broadcast indicates IAB support for the selected PLMN or the selected SNPN).

A WTRU may transition to RRC_IDLE. On transition from RRC_CONNECTED or RRC_INACTIVE to RRC_IDLE, a WTRU may camp on a cell as result of cell selection according to the frequency (e.g., assigned by RRC in the state transition message if any).

A WTRU may recover from out of coverage. The WTRU may attempt to find a suitable cell in the manner described for stored information or initial cell selection herein. in some examples, if no suitable cell may be found on any frequency or RAT, the WTRU may attempt to find an acceptable cell.

In multi-beam operations, the cell quality may be derived amongst the beams corresponding to the same cell.

Cell Reselection may be described herein. A WTRU in RRC_IDLE may perform cell reselection. The principles of the procedure may be one or more of the following: cell reselection may be based on CD-SSBs located on the synchronization raster; the WTRU may make measurements of attributes of the serving and neighbor cells to enable the reselection process (e.g., for the search and measurement of inter-frequency neighboring cells, the carrier frequencies (e.g., only the carrier frequencies) may be indicated); cell reselection may identify the cell that the WTRU may camp on. It may be based on cell reselection criteria which involves measurements of the serving and neighbor cells (e.g., intra-frequency reselection may be based on ranking of cells; inter-frequency reselection may be based on absolute priorities where a WTRU tries to camp on the highest priority frequency available; a neighbor cell list (NCL) may be provided by the serving cell to handle specific cases for intra-and inter-frequency neighboring cells; exclude-lists may be provided to prevent the WTRU from reselecting to specific intra-and inter-frequency neighboring cells; allow-lists may be provided to request the WTRU to reselect to specific intra-and inter-frequency neighboring cells (e.g., only specific intra-and inter-frequency neighboring cells); cell reselection may be speed dependent; service specific prioritization; slice specific cell reselection information may be provided to facilitate the WTRU to reselect a cell that supports specific slices). In multi-beam operations, the cell quality may be derived amongst the beams corresponding to the same cell.

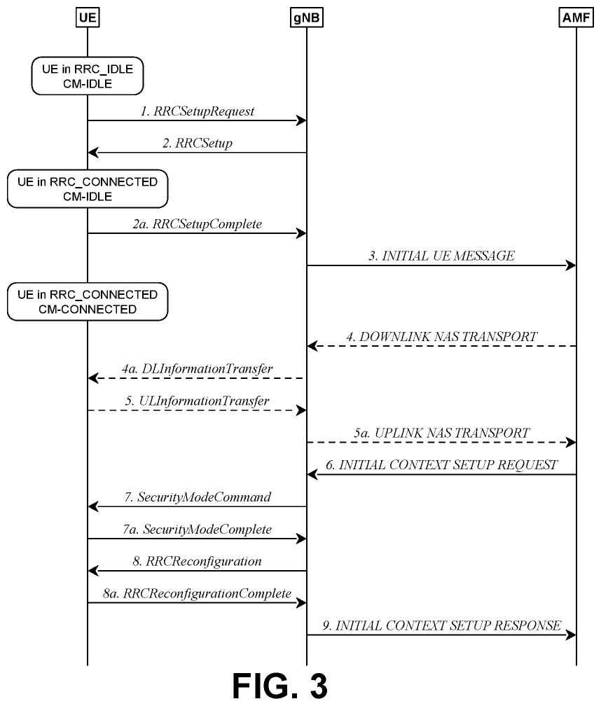

A WTRU may perform state transitions. FIG. 3 is an example of a WTRU triggered transition from RRC_IDLE to RRC_CONNECTED. FIG. 3 describes the WTRU triggered transition from RRC_IDLE to RRC_CONNECTED (e.g., NAS part may also be provided). At 1, the WTRU may request to set up a different connection (e.g., a new connection) from RRC_IDLE. At 2/2a, the gNB may complete the RRC setup procedure. The scenario where the gNB rejects the request may be described herein. At 3, the first NAS message from the WTRU, piggybacked in RRCSetupComplete, may be sent to AMF. At 4/4a/5/5a, additional NAS messages may be exchanged between WTRU and AMF. At 6, the AMF may prepare the WTRU context data (including protocol data unit (PDU) session context, the Security Key, WTRU radio capability and WTRU Security Capabilities, etc.) and may send it to the gNB. At 7/7a, the gNB may activate the AS security with the WTRU. At 8/8a, the gNB may perform the reconfiguration to set up signaling radio bearer (SRB)2 and data radio bearers (DRBs) for WTRU, or SRB2 and optionally DRBs for Integrated Access and Backhaul (IAB)-Mobile Termination (MT). At 9, the gNB may inform the AMF that the setup procedure may be completed. RRC messages at 1 and 2 may use SRB0, some or all the subsequent messages may use SRB1. Messages at 7/7a may be integrity protected. From 8 on, some or all the messages may be integrity protected and ciphered. For signaling only connection, 8 may be skipped since SRB2 and DRBs may not be set up.

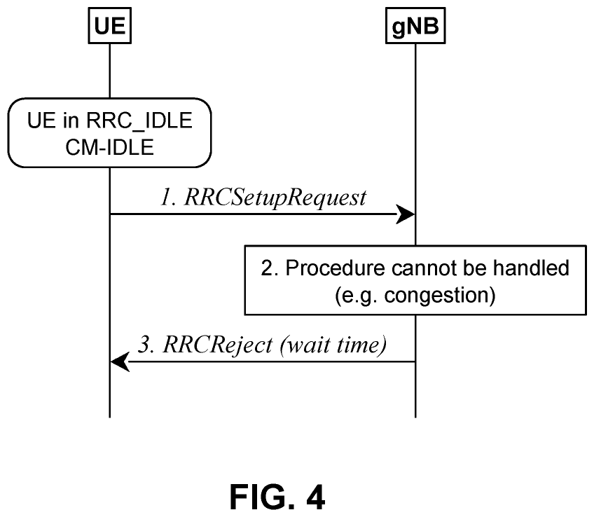

FIG. 4 is an example of a rejection of WTRU triggered transition from RRC_IDLE. FIG. 4 describes the rejection from the network when the WTRU attempts to set up a connection from RRC_IDLE. At 1, a WTRU may attempt to set up a different connection (e.g., a new connection) from RRC_IDLE. At 2, the gNB may not be able to handle the procedure, for instance due to congestion. At 3, the gNB may send RRC Reject (with a wait time) to keep the WTRU in RRC_IDLE.

Mobility in RRC_INACTIVE may be described herein.

RRC_INACTIVE may be a state where a WTRU remains in CM-CONNECTED and may move within an area configured by next generate (NG)-RAN (the RNA) without notifying NG-RAN. In RRC_INACTIVE, the last serving gNB node may keep the WTRU context and the WTRU-associated NG connection with the serving AMF and UPF.

If the last serving gNB may receive DL data from the UPF or DL WTRU-associated signaling from the AMF (except the WTRU Context Release Command message, e.g., the UE context release as defined in 3GPP) while the WTRU may be in RRC_INACTIVE, it may page in the cells corresponding to the RNA and may send Xn application protocol (XnAP) RAN paging to neighbor gNB(s) if the RNA includes cells of neighbor gNB(s).

Upon receiving the WTRU Context Release Command message while the WTRU may be in RRC_INACTIVE, the last serving gNB may page in the cells corresponding to the RNA and may send XnAP RAN paging to neighbor gNB(s) if the RNA includes cells of neighbor gNB(s), in order to release WTRU explicitly.

Upon receiving the NG RESET message while the WTRU may be in RRC_INACTIVE, the last serving gNB may page involved WTRUs in the cells corresponding to the RNA and may send XnAP RAN paging to neighbor gNB(s) if the RNA includes cells of neighbor gNB(s) in order to explicitly release involved WTRUS.

Upon RAN paging failure, the gNB may behave accordingly.

The AMF may provide to the NG-RAN node the Core Network Assistance Information to assist the NG-RAN node's decision whether the WTRU may be sent to RRC_INACTIVE, and to assist WTRU configuration and paging in RRC_INACTIVE. The Core Network Assistance Information may include the registration area configured for the WTRU, the Periodic Registration Update timer, and the WTRU Identity Index value, and may include the WTRU specific discontinuous reception (DRX), an indication if the WTRU may be configured with Mobile Initiated Connection Only (MICO) mode by the AMF, the expected WTRU behavior, the WTRU radio capability for paging, the paging early indication (PEI) with paging subgrouping assistance information and the NR paging eDRX Information and paging cause Indication for Voice Service. The WTRU registration area may be taken into account by the NG-RAN node when configuring the RNA. The WTRU specific DRX and WTRU Identity Index value may be used by the NG-RAN node for RAN paging. The Periodic Registration Update timer may be taken into account by the NG-RAN node to configure periodic RNA update timer. The NG-RAN node may take into account the expected WTRU behavior to assist the WTRU RRC state transition decision. The NG-RAN node may use the WTRU radio capability for paging during RAN paging. The NG-RAN node may take into account the PEI with paging subgrouping assistance information for subgroup paging in RRC_INACTIVE. When sending the XnAP RAN paging to neighbor NG-RAN node(s), the PEI with paging subgrouping assistance information may be included. The NG-RAN node may take into account the NR paging eDRX Information to configure the RAN paging when the NR WTRU may be in RRC_INACTIVE. When sending XnAP RAN paging to neighbor NG-RAN node(s), the NR paging eDRX Information for RRC_IDLE and for RRC_INACTIVE may be included. The NG-RAN node may take into consideration the paging cause Indication for Voice Service to include the paging cause in RAN paging for a WTRU in RRC_INACTIVE state. When sending XnAP RAN paging to neighbor NG-RAN node(s), the paging cause may be included.

At transition to RRC_INACTIVE the NG-RAN node may configure the WTRU with a periodic RNA Update timer value. At periodic RNA Update timer expiry without notification from the WTRU, the gNB may behave accordingly.

If the WTRU accesses a gNB other than the last serving gNB, the receiving gNB may trigger the XnAP Retrieve UE Context procedure to get the WTRU context from the last serving gNB and may also trigger an Xn-U Address Indication procedure including tunnel information for potential recovery of data from the last serving gNB. Upon successful WTRU context retrieval, the receiving gNB may perform the slice-aware admission control in case of receiving slice information and may become the serving gNB and it further triggers the NGAP Path Switch Request and applicable RRC procedures. After the path switch procedure, the serving gNB may trigger release of the WTRU context at the last serving gNB by means of the XnAP WTRU Context Release procedure.

In case the WTRU may not be reachable at the last serving gNB, the gNB may fail a (e.g., any) AMF initiated WTRU-associated class 1 procedure which allows the signaling of unsuccessful operation in the respective response message. It may trigger the NAS non delivery Indication procedure to report the non-delivery of any non PDU session related NAS PDU received from the AMF.

If the WTRU accesses a gNB other than the last serving gNB and the receiving gNB does not find a valid WTRU Context, the receiving gNB may perform establishment of a different RRC connection (e.g., a new RRC connection), e.g., instead of resumption of the previous RRC connection. WTRU context retrieval may also fail and hence a different RRC connection (e.g., a new RRC connection) may be established if the serving AMF changes.

A WTRU in the RRC_INACTIVE state may be required to initiate RNA update procedure when it moves out of the configured RNA. When receiving RNA update request from the WTRU, the receiving gNB may trigger the XnAP Retrieve WTRU Context procedure to get the WTRU context from the last serving gNB and may decide to send the WTRU back to RRC_INACTIVE state, move the WTRU into RRC_CONNECTED state, or send the WTRU to RRC_IDLE. In case of periodic RNA update, if the last serving gNB decides not to relocate the WTRU context, it fails the Retrieve WTRU Context procedure and may send the WTRU back to RRC_INACTIVE, or to RRC_IDLE directly by an encapsulated RRC release message.

Cell Reselection may be performed. A WTRU in RRC_INACTIVE may perform cell reselection. The principles of the procedure may be as for the RRC_IDLE state.

RAN-Based Notification Area may be used. A WTRU in the RRC_INACTIVE state may be configured by the last serving NG-RAN node with a RNA, where: the RNA may cover a single or multiple cells, and may be contained within the CN registration area; Xn connectivity may be available within the RNA; a RAN-based notification area update (RNAU) may be periodically sent by the WTRU and may be also sent when the cell reselection procedure of the WTRU selects a cell that does not belong to the configured RNA.

There may be several alternatives on how the RNA may be configured: List of cells (e.g., a WTRU may be provided an explicit list of one or more cells that constitute the RNA); list of RAN areas (e.g., a WTRU may be provided one or more RAN area ID, where a RAN area may be a subset of a CN Tracking Area or equal to a CN Tracking Area; a RAN area may be specified by one RAN area ID, which may include a TAC and optionally a RAN area code; a cell may broadcast one or more RAN area IDs in the system information).

NG-RAN may provide different RNA definitions to different WTRUs (e.g., NG-RAN may not mix different definitions to the same WTRU at the same time). WTRU(s) may support some or all RNA configuration options listed above.

State transitions may occur. A WTRU triggered transition from RRC_INACTIVE to RRC_CONNECTED may occur.

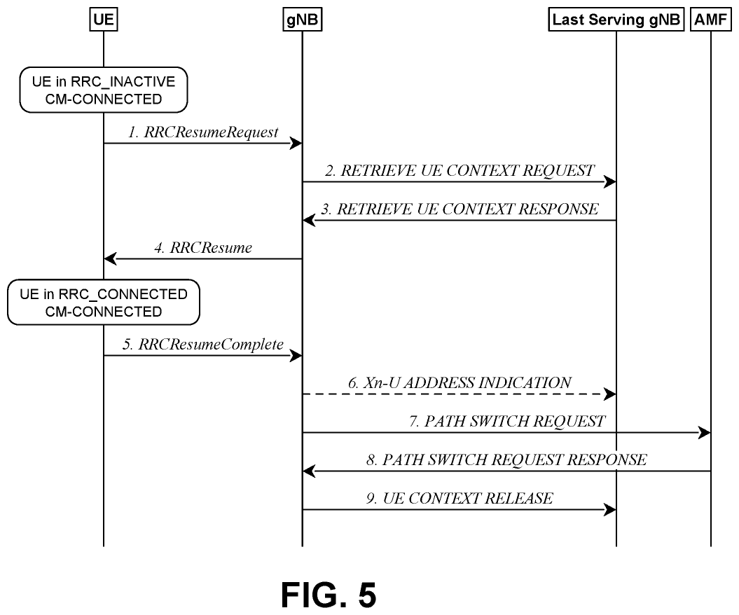

FIG. 5 is an example of a WTRU triggered transition from RRC_INACTIVE to RRC_CONNECTED (WTRU context retrieval success). FIG. 5 describes the WTRU triggered transition from RRC_INACTIVE to RRC_CONNECTED in case of WTRU context retrieval success. At 1, the WTRU may resume from RRC_INACTIVE, providing the inactive radio network temporary identifier (I-RNTI), allocated by the last serving gNB. At 2, the gNB, if able to resolve the gNB identity contained in the I-RNTI, may request the last serving gNB to provide WTRU Context data. At 3, the last serving gNB may provide WTRU context data. At 4/5, the gNB and WTRU may complete the resumption of the RRC connection. User Data may also be sent at 5 if the grant allows. At 6, if loss of DL user data buffered in the last serving gNB may be prevented, the gNB may provide forwarding addresses. At 7/8, the gNB may perform path switch. At 9, the gNB may trigger the release of the WTRU resources at the last serving gNB. After 1 above, when the gNB decides to use a single RRC message to reject the Resume Request (e.g., right away) and keep the WTRU in RRC_INACTIVE, for example, without any reconfiguration (e.g., as described in the two examples below), or when the gNB decides to set up a different RRC connection (e.g., a new RRC connection), SRB0 (without security) may be used. Conversely, when the gNB decides to reconfigure the WTRU (e.g., with a new DRX cycle or RNA) or when the gNB decides to push the WTRU to RRC_IDLE, SRB1 (with integrity protection and ciphering as previously configured for that SRB) may be used. SRB1 may be used (e.g., only be used) once the WTRU Context may be retrieved (e.g., after 3).

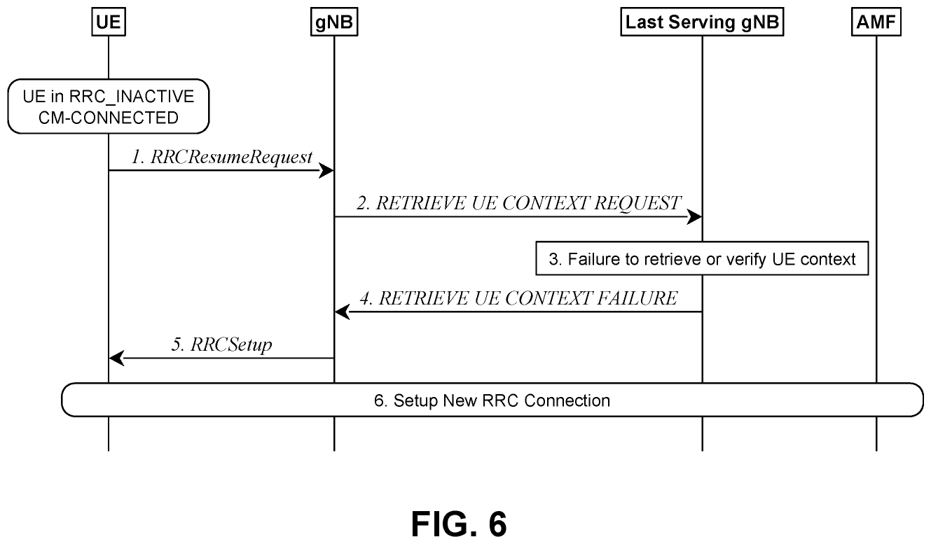

FIG. 6 is an example of a WTRU triggered transition from RRC_INACTIVE to RRC_CONNECTED (WTRU context retrieval failure). FIG. 6 describes the WTRU triggered transition from RRC_INACTIVE to RRC_CONNECTED in case of WTRU context retrieval failure. At 1, the WTRU may resume from RRC_INACTIVE, providing the I-RNTI, allocated by the last serving gNB. At 2, the gNB, if able to resolve the gNB identity contained in the I-RNTI, may request the last serving gNB to provide WTRU Context data. At 3, the last serving gNB, may not retrieve or verify the WTRU context data. At 4, the last serving gNB may indicate the failure to the gNB. At 5, the gNB may perform a fallback to establish a different RRC connection (e.g., a new RRC connection) by sending RRCSetup. At 6, a different connection (e.g., a new connection) may be set up.

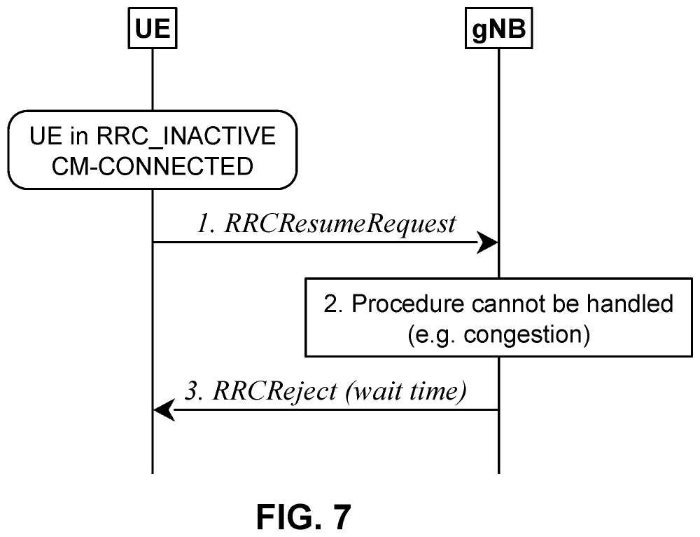

FIG. 7 is an example of a rejection from the network when a WTRU attempts to resume a connection. FIG. 7 describes the rejection form the network when the WTRU attempts to resume a connection from RRC_INACTIVE. At 1, WTRU may attempt to resume the connection from RRC_INACTIVE. At 2, the gNB may not be able to handle the procedure, for instance due to congestion. AT 3, the gNB may send RRC Reject (with a wait time) to keep the WTRU in RRC_INACTIVE.

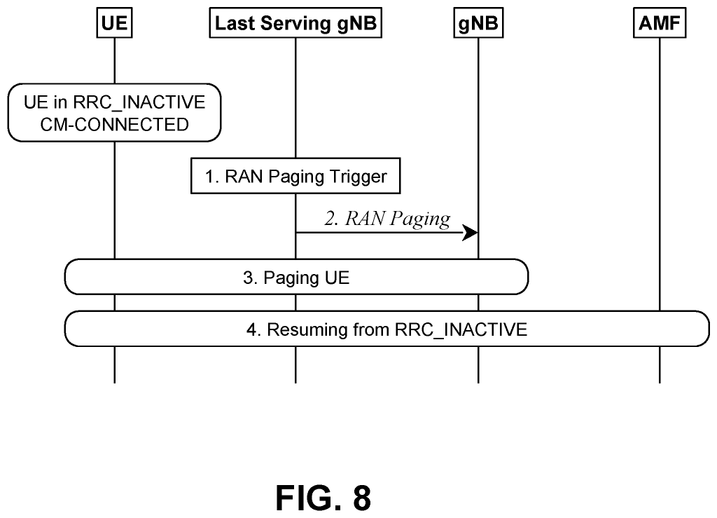

Network triggered transition from RRC_INACTIVE to RRC_CONNECTED may occur. FIG. 8 is an example of a network triggered transition from RRC_INACTIVE to RRC_CONNECTED. FIG. 8 describes the network triggered transition from RRC_INACTIVE to RRC_CONNECTED. At 1, a RAN paging trigger event may occur (incoming DL user plane, DL signaling from 5GC, etc.). At 2, RAN paging may be triggered (e.g., either only in the cells controlled by the last serving gNB or also by means of Xn RAN paging in cells controlled by other gNBs, configured to the WTRU in the RAN-based notification area (RNA)). At 3, the WTRU may be paged with the I-RNTI. At 4, if the WTRU has been successfully reached, it may attempt to resume from RRC_INACTIVE.

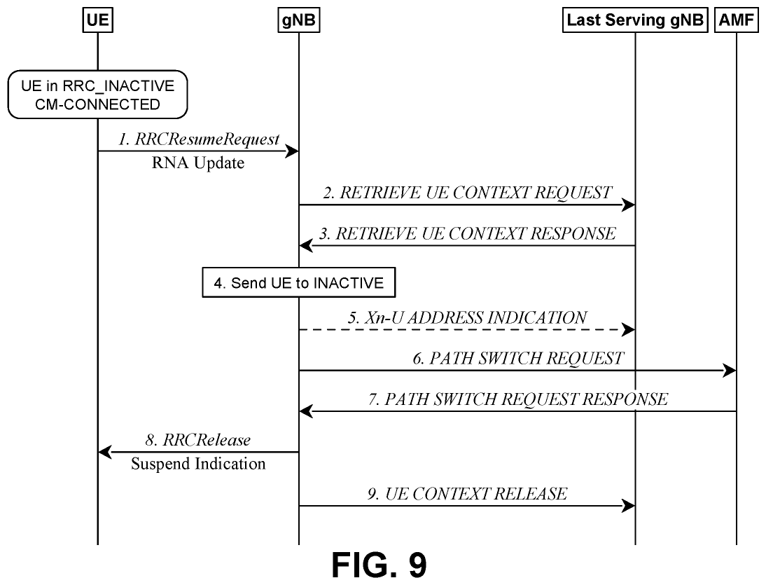

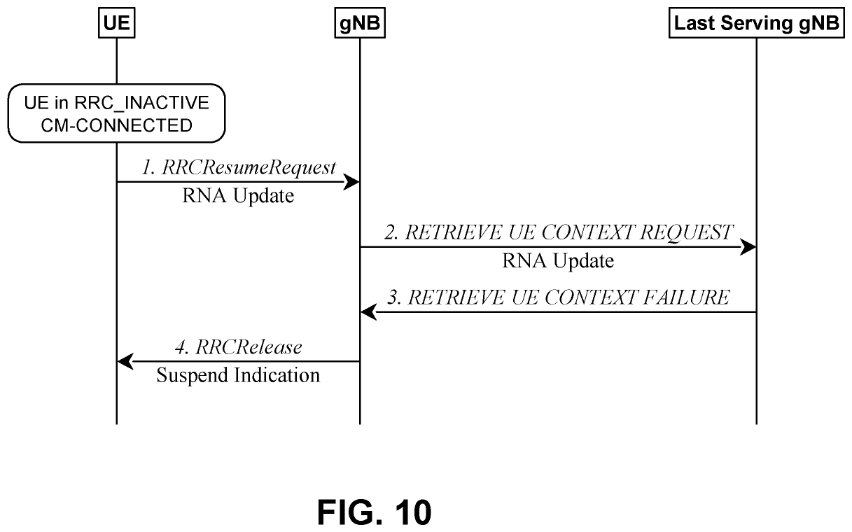

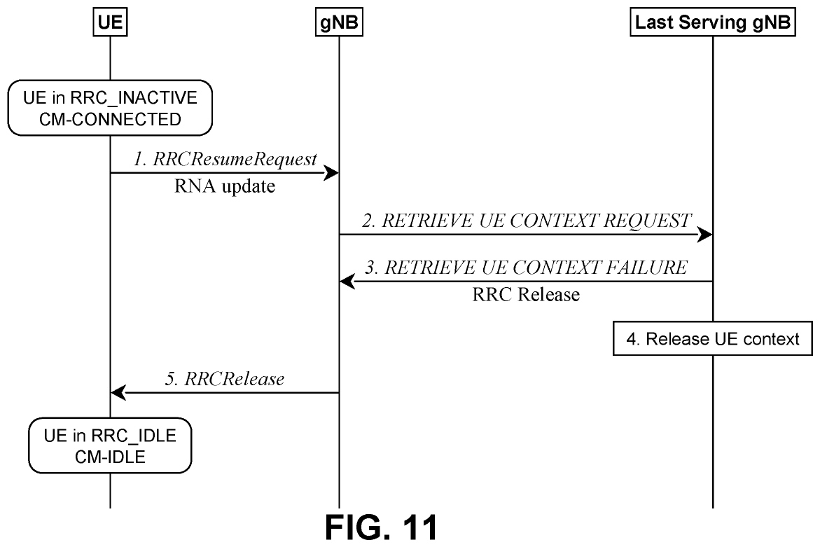

RNA update may be performed. FIG. 9 is an example of a RNA update procedure with WTRU context relocation. FIG. 9 describes the WTRU triggered RNA update procedure involving context retrieval over Xn. The procedure may be triggered when the WTRU moves out of the configured RNA, or periodically. At 1, the WTRU may resume from RRC_INACTIVE, providing the I-RNTI allocated by the last serving gNB and appropriate cause value, e.g., RAN notification area update. At 2, the gNB, if able to resolve the gNB identity contained in the I-RNTI, may request the last serving gNB to provide WTRU Context, providing the cause value received at 1. At 3, the last serving gNB may provide the WTRU context (as assumed in the following). Alternatively, the last serving gNB may decide to move the WTRU to RRC_IDLE (and the procedure follows 3 and later of FIG. 11) or, if the WTRU may be still within the previously configured RNA, to keep the WTRU context in the last serving gNB and to keep the WTRU in RRC_INACTIVE (and the procedure follows 3 and later of FIG. 10). At 4, the gNB may move the WTRU to RRC_CONNECTED (and the procedure follows 4 of FIG. 5) or send the WTRU back to RRC_IDLE (in which case an RRC release message may be sent by the gNB), or send the WTRU back to RRC_INACTIVE as assumed in the following. At 5, if loss of DL user data buffered in the last serving gNB may be prevented, the gNB may provide forwarding addresses. At 6/7, the gNB may perform path switch. At 8, the gNB may keep the WTRU in RRC_INACTIVE state by sending RRC release with suspend indication. At 9, the gNB may trigger the release of the WTRU resources at the last serving gNB.

FIG. 10 is an example of a periodic RNA update procedure without WTRU context relocation. FIG. 10 describes the RNA update procedure for the case when the WTRU may be still within the configured RNA and the last serving gNB decides not to relocate the WTRU context and to keep the WTRU in RRC_INACTIVE. At 1, the WTRU may resume from RRC_INACTIVE, providing the I-RNTI allocated by the last serving gNB and appropriate cause value, e.g., RAN notification area update. At 2, the gNB, if able to resolve the gNB identity contained in the I-RNTI, may request the last serving gNB to provide WTRU Context, providing the cause value received at 1. At 3, the last serving gNB may store received information to be used in the next resume attempt (e.g., cell-RNTI and physical cell ID (PCI) related to the resumption cell), and may respond to the gNB with the RETRIEVE UE CONTEXT FAILURE message including an encapsulated RRC release message. The RRC release message may include Suspend Indication. At 4, the gNB may forward the RRC release message to the WTRU.

FIG. 11 is an example of a RNA update procedure with transition to RRC_IDLE. FIG. 11 describes the RNA update procedure for the case when the last serving gNB decides to move the WTRU to RRC_IDLE. At 1, the WTRU may resume from RRC_INACTIVE, providing the I-RNTI allocated by the last serving gNB and appropriate cause value, e.g., RAN notification area update. At 2, the gNB, if able to resolve the gNB identity contained in the I-RNTI, may request the last serving gNB to provide WTRU Context, providing the cause value received at 1. At 3, instead of providing the WTRU context, the last serving gNB may provide an RRC release message to move the WTRU to RRC_IDLE. At 4, the last serving gNB may delete the WTRU context. At 5, the gNB may send the RRC release which triggers the WTRU to move to RRC_IDLE.

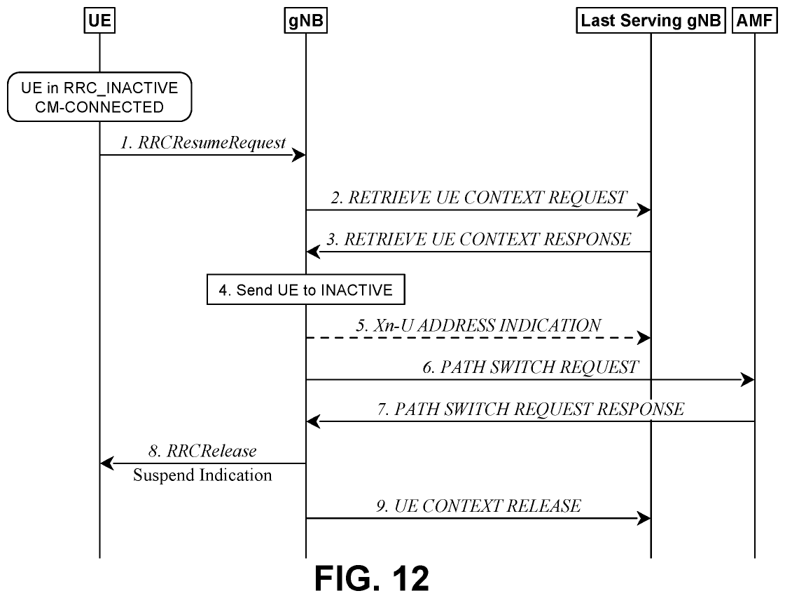

Resume request responded with Release with Redirect, with WTRU context relocation may be used. FIG. 12 is an example of a resume request responded with release with redirect, with WTRU context relocation. FIG. 12 describes a WTRU triggered NAS procedure responded by the network with a release with redirect, with WTRU context relocation. At 1, the WTRU may resume from RRC_INACTIVE, providing the I-RNTI allocated by the last serving gNB. At 2, the gNB, if able to resolve the gNB identity contained in the I-RNTI, may request the last serving gNB to provide WTRU Context data. At 3, the last serving gNB may provide the WTRU context. At 4, the gNB may move the WTRU to RRC_CONNECTED (and the procedure follows 4 of FIG. 5), or send the WTRU back to RRC_IDLE (in which case an RRC release message may be sent by the gNB), or send the WTRU back to RRC_INACTIVE, including a release with redirect indication (as assumed in the following). At 5, if loss of DL user data buffered in the last serving gNB may be prevented, the gNB may provide forwarding addresses. At 6/7, the gNB may perform path switch. At 8, the gNB may keep the WTRU in RRC_INACTIVE state by sending RRC release with suspend indication, including redirection information (frequency layer the WTRU performs cell selection upon entering RRC_INACTIVE). At 9, the gNB may trigger the release of the WTRU resources at the last serving gNB. Upon receiving the release with redirect, the higher layers may trigger a pending procedure so the WTRU may try to resume again after cell selection.

Paging may be used. Paging may allow the network to reach WTRUs in RRC_IDLE and in RRC_INACTIVE state through paging messages, and to notify WTRUs in RRC_IDLE, RRC_INACTIVE and RRC_CONNECTED state of system information change and earthquake and tsunami warning system (ETWS)/ commercial mobile alert system (CMAS) indications through short messages. Both paging messages and short messages may be addressed with paging (P)-RNTI on physical downlink control channel (PDCCH) (e.g., but while the former may be sent on PCCH, the latter may be sent over PDCCH directly).

While in RRC_IDLE the WTRU may monitor the paging channels for CN-initiated paging. While in RRC_INACTIVE with no ongoing SDT procedure, the WTRU may monitor paging channels for RAN-initiated paging and CN-initiated paging. A WTRU may not need to monitor paging channels continuously; a paging DRX may be where the WTRU in RRC_IDLE or RRC_INACTIVE may (e.g., only required to) monitor paging channels during one paging occasion (PO) per DRX cycle. The paging DRX cycles may be configured by the network: for CN-initiated paging, a default cycle may be broadcast in system information; for CN-initiated paging, a WTRU specific cycle can be configured via NAS signaling; for RAN-initiated paging, a WTRU-specific cycle may be configured via RRC signaling (e.g., the WTRU may use the shortest of the DRX cycles applicable; for example, a WTRU in RRC_IDLE may use the shortest of the first two cycles above, while a WTRU in RRC_INACTIVE may use the shortest of the three).

The POs of a WTRU for CN-initiated and RAN-initiated paging may be based on the same WTRU ID, resulting in overlapping POs for both. The number of different POs in a DRX cycle may be configurable via system information and a network may distribute WTRUs to those POs based on their IDs.

While in RRC_CONNECTED and while in RRC_INACTIVE with ongoing small data transmission (SDT) procedure, the WTRU may monitor the paging channels in a (e.g., any) PO signaled in system information for SI change indication and public warning system (PWS) notification. In case of bandwidth adaptation (BA), a WTRU in RRC_CONNECTED may monitor (e.g., only monitor) paging channels on the active BWP with common search space configured.

For operation with shared spectrum channel access, a WTRU may be configured for an additional number of PDCCH monitoring occasions in its PO to monitor for paging. When the WTRU detects a PDCCH transmission within the WTRU's PO addressed with P-RNTI, the WTRU may not be required to monitor the subsequent PDCCH monitoring occasions within this PO.

If paging cause may be included in the paging message, a WTRU in RRC_IDLE or RRC_INACTIVE state may use the paging cause.

Paging optimization for WTRUs in CM_IDLE may be performed: at WTRU context release, the NG-RAN node may provide the AMF with a list of recommended cells and NG-RAN nodes as assistance information for subsequent paging. The AMF may also provide paging attempt information including a paging attempt count and the intended number of paging attempts and may include the next paging area scope. If paging attempt information may be included in the paging message, a (e.g., each) paged NG-RAN node may receive the same information during a paging attempt. The paging attempt count may be increased by one at a (e.g., each) new paging attempt. The next paging area scope, when present, may indicate whether the AMF plans to modify the paging area currently selected at the next paging attempt. If the WTRU has changed its state to CM CONNECTED the paging attempt count may be reset.

Paging optimization for WTRUs in RRC_INACTIVE may be performed: at RAN paging, the serving NG-RAN node may provide RAN paging area information. The serving NG-RAN node may also provide RAN paging attempt information. A (e.g., each) paged NG-RAN node may receive the same RAN paging attempt information during a paging attempt with the following content: paging attempt count, the intended number of paging attempts and the next paging area scope. The paging attempt count may be increased by one at a (e.g., each) new paging attempt. The next paging area scope, when present, may indicate whether the serving NG_RAN node plans to modify the RAN paging area currently selected at next paging attempt. If the WTRU leaves RRC_INACTIVE state, the paging attempt count may be reset.

WTRU power saving for paging monitoring may be used: in order to reduce WTRU power consumption due to false paging alarms, the group of WTRUs monitoring the same PO may be further divided into multiple subgroups. With subgrouping, a WTRU may monitor PDCCH in its PO for paging if the subgroup to which the WTRU belongs may be paged as indicated via associated PEI. If a WTRU cannot find its subgroup ID with the PEI configurations in a cell or if the WTRU may be unable to monitor the associated PEI occasion corresponding to its PO, it may monitor the paging in its PO. These subgroups may have the following characteristics: they may be formed based on either CN controlled subgrouping or WTRU ID based subgrouping; if CN controlled subgroup ID may not be provided from AMF, WTRU ID based subgrouping may be used if supported by the WTRU and network; the RRC state (e.g., RRC_IDLE or RRC_INACTIVE state) may not impact which subgroup the WTRU belongs to; subgrouping support for a cell may be broadcast in the system information as one of the following (e.g., only CN controlled subgrouping supported, only WTRU ID based subgrouping supported, or both CN controlled subgrouping and WTRU ID based subgrouping supported); total number of subgroups allowed in a cell may be up to 8 and may represent the sum of CN controlled and WTRU ID based subgrouping configured by the network; a WTRU configured with CN controlled subgroup ID may apply CN controlled subgroup ID if the cell supports CN controlled subgrouping; otherwise, it may derive WTRU ID based subgroup ID (e.g., if the cell supports only WTRU ID based subgrouping).

PEI associated with subgroups may have the following characteristics: if the PEI may be supported by the WTRU, it may at least support WTRU ID based subgrouping method; PEI monitoring may be limited via system information to the cell in which its last connection was released (e.g., unless the network indicates that the WTRU shall not update its last used cell information); a PEI-capable WTRU may store its last used cell information; gNBs supporting the PEI monitoring to the last used cell function may provide the WTRU's last used cell information to the AMF in the NG-AP UE Context Release Complete message for PEI capable WTRUs; WTRU that expects multicast and broadcast services (MBS) group notification may ignore the PEI and may monitor paging in its PO.

CN controlled subgrouping may be used: For CN controlled subgrouping, AMF may be responsible for assigning subgroup ID to the WTRU. The total number of subgroups for CN controlled subgrouping which can be configured, e.g., by operations, administration, and maintenance (OAM), may be up to a certain number (e.g., 8). It may be assumed that CN controlled subgrouping support may be homogeneous within a RNA.

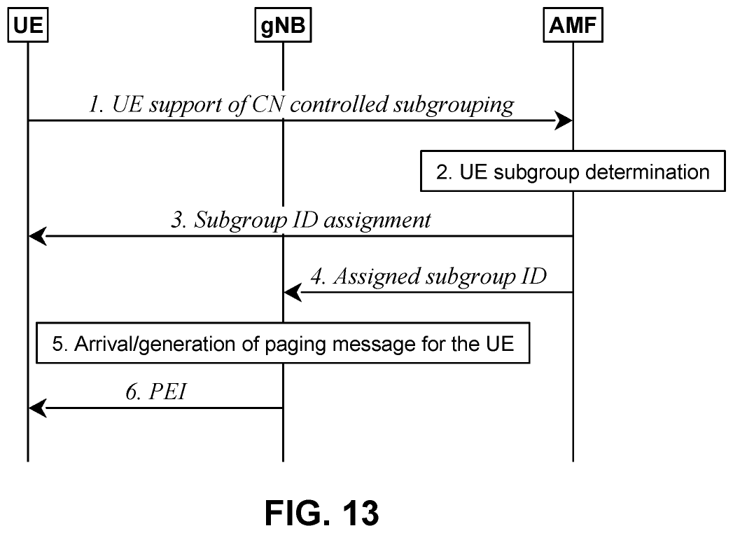

FIG. 13 is an example procedure for CN controlled subgrouping. FIG. 13 describes the procedure for CN controlled subgrouping. At 1, the WTRU may indicate its support of CN controlled subgrouping via NAS signaling. At 2, if the WTRU supports CN controlled subgrouping, the AMF may determine the subgroup ID assignment for the WTRU. At 3, the AMF may send subgroup ID to the WTRU via NAS signaling. At 4, the AMF may inform the gNB about the CN assigned subgroup ID for paging the WTRU in RRC_IDLE/RRC_INACTIVE state. At 5, when the paging message for the WTRU may be received from the CN or may be generated by the gNB, the gNB may determine the PO and the associated PEI occasion for the WTRU. At 6, before the WTRU may be paged in the PO, the gNB may transmit the associated PEI and indicate the corresponding CN controlled subgroup of the WTRU that is to be paged in the PEI.

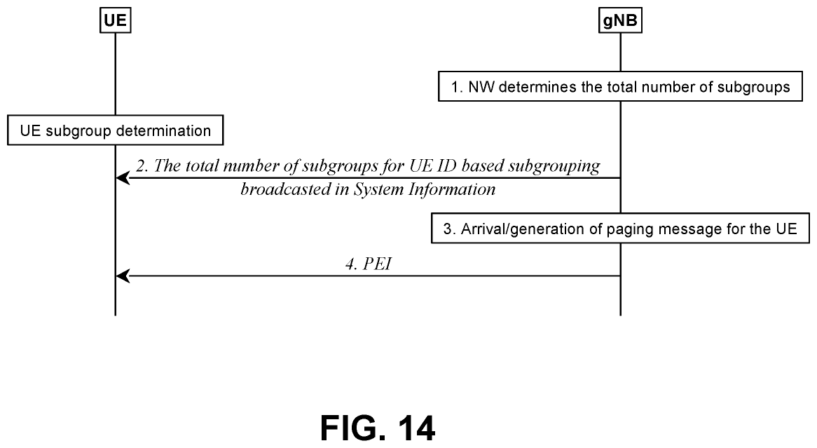

WTRU ID based subgrouping may be used. For WTRU ID based subgrouping, the gNB and WTRU may determine the subgroup ID based on the WTRU ID and the total number of subgroups for WTRU ID based subgrouping in the cell. The total number of subgroups for WTRU ID based subgrouping may be decided by the gNB for a (e.g., each) cell and may be different in different cells. FIG. 14 is an example procedure for WTRU ID based subgrouping. FIG. 14 describes the procedure for WTRU ID based subgrouping. At 1, the gNB may determine the total number of subgroups for WTRU ID based subgrouping in a cell. At 2, the gNB may broadcast the total number of subgroups for WTRU ID based subgrouping in a cell. At 3, when paging message for the PEI capable WTRU may be received from the CN at the gNB or may be generated by the gNB, the gNB may determine the PO and the associated PEI occasion for the WTRU. At 4, before the WTRU may be paged in the PO, the gNB may transmit the associated PEI and indicate the corresponding subgroup derived based on WTRU ID of the WTRU that may be paged in the PEI.

Extended DRX for RRC_IDLE and RRC_INACTIVE may be used. When extended DRX (eDRX) may be used, the following may apply. For RRC_INACTIVE, eDRX configuration for RAN paging may be decided and configured by NG-RAN. In RRC_INACTIVE the WTRU may monitor both RAN and CN paging. For RRC_IDLE, eDRX for CN paging may be configured by upper layers. In RRC_IDLE the WTRU may monitor CN paging (e.g., only CN paging). Information on whether eDRX may be allowed on the cell for WTRUs in RRC_IDLE and RRC_INACTIVE may be provided separately for RRC_IDLE and RRC_INACTIVE in system information. The maximum value of the eDRX cycle may be 10485.76 seconds (2.91 hours) for RRC_IDLE and 10.24 seconds for RRC_INACTIVE, while the minimum value of the eDRX cycle may be 2.56 seconds for both RRC_IDLE and RRC_INACTIVE. The hyper system frame number (H-SFN) may be broadcast by the cell and increments by one when the SFN wraps around; paging hyperframe (PH) may refer to the H-SFN in which the WTRU starts monitoring paging DRX during a paging time window (PTW) used in RRC_IDLE. The PH and PTW may be determined based on a formula that may be known by the AMF, WTRU and NG-RAN. H-SFN, PH and PTW may be used if the eDRX cycle may be greater than 10.24 seconds. When the eDRX cycle may be longer than the system information modification period, the WTRU may verify that stored system information remains valid before establishing an RRC connection.

NR NTN (Non-Terrestrial Networks) enhancements (e.g., NTN-TN and NTN-NTN mobility and service continuity enhancements) may include one or more of the following. NTN-TN and NTN-NTN measurement/mobility and service continuity enhancements may be specified. For NTN-NTN mobility, cell reselection (e.g., cell reselection enhancements) for earth moving cell, the timing based and/or location-based cell reselection for quasi-earth fixed cell may be considered. NTN-NTN handover (e.g., NTN-NTN handover enhancement) for RRC_CONNECTED WTRUs in the quasi-earth-fixed cell and/or earth-moving cell to reduce the signalling overhead may be specified. Cell reselection (e.g., cell reselection enhancements) for RRC_IDLE/INACTIVE WTRUs to reduce WTRU power consumption (NTN-TN mobility may be prioritized) may be specified. Enhancement to Xn[/NG] signalling to support a feeder link switch-over, CHO, e.g., an exchange of information such as necessary information between gNBs, may be specified.

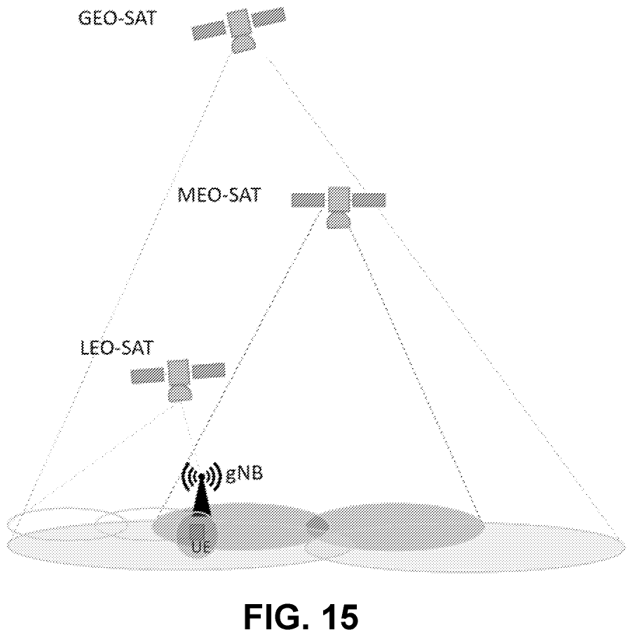

A network may include several layers (e.g., TN and one or more of LEO, MEO and GEO satellites), which may operate with different cell sizes and with different over-the-air propagation delays (e.g., each of the layers may operate with a different cell size and/or a different over-the-air propagation delay). FIG. 15 is an example of NTN-TN network layers. In examples (e.g., the example shown in FIG. 15), a GEO (e.g., a satellite or a cell) may have the largest cell coverage (e.g., with the longest propagation delay) among TN, LEO, MEO, and GEO, followed by MEO, then LEO, which may have a smaller cell coverage and/or a shorter propagation delay than GEO and MEO, and the TN, which may have the smallest cell coverage and the shortest propagation delay among TN, LEO, MEO, and GEO.

Although one or more examples herein may refer to a TN vs. NTN coverage, the principle(s), process(es), instrumentalit(ies), and system(s) may be applied to any combination of network layers (e.g., LEO vs. GEO, TN vs. MEO vs. GEO, and so on).

If a TN coverage and an NTN coverage are available for a WTRU, the WTRU may camp on an NTN cell, for example, which may advantageously provide benefits from a WTRU power saving point of view even when the WTRU is in an RRC_INACTIVE state (e.g., mode/operating condition). In examples, an NTN cell may have a wider coverage (e.g., as shown in FIG. 15) than a TN cell (or multiple TN cells combined), which may minimize (e.g., particularly for a moving WTRU) one or more of the following: neighbour cell measurements; cell reselection(s); system information (SI) reading.

A WTRU may camp on an NTN cell, which may additionally advantageously provide benefits, for example, from an NW paging load point of view. For example, if a TN coverage and an NTN coverage are available for the WTRU, the WTRU may camp on an NTN cell, for example, when the WTRU is in an RRC inactive state. One or more cell reselection approaches described in one or more examples that are used for a WTRU in an RRC_INACTIVE state may be used for a WTRU in an RRC_IDLE state (e.g., the same or similar cell reselection method may be used for both RRC_IDLE and RRC_INACTIVE, for example, different parameters (e.g., cell reselection priority, threshold) may be configured but the process may be the same or similar). In examples, when an NTN cell has a wider coverage (e.g., as shown in FIG. 15) than a TN cell or multiple TN cells combined, a WTRU cell location (e.g., the cell in which the WTRU is camped) may be known and/or easier to obtain. For example, when a WTRU cell location is known, or known with a greater confidence (e.g., based on a higher likelihood, a higher statistical possibility, or an increased reliability of related indication(s)), paging may not need to be escalated across multiple cells within a RNA. In examples, in a TN cell, a WTRU may perform a cell reselection in an RRC_INACTIVE state within a RNA, for example, without notifying a network. The network may page in multiple cells, for example, to find a location of a WTRU. In some examples, in an NTN cell with a relatively wide coverage (e.g., a GEO satellite), a cell location associated with a WTRU may be or is more likely to be known, for example, because the WTRU may not need to reselect to another cell. In an NTN cell with a medium coverage (e.g., another NTN cell such as an LEO, earth moving), the cell location may be known with a greater confidence (e.g., the potential cells in which the WTRU may be camped may be a limited number compared to, for example, the TN). For example, in an NTN cell with a medium coverage, the cell location may be known with a greater confidence even in case of a cell reselection within a TA/RNA (e.g., since the WTRU may not have moved significantly within the geographical area). In one or more examples herein, a WTRU cell location may refer to a cell, a carrier, a band, a subband, and/or a BWP in which the WTRU is camped.

If a TN coverage and an NTN coverage are available for a WTRU, the WTRU may camp on a TN cell, which may advantageously provide benefits, for example, from a latency point of view. In some examples, a TN cell may be a better choice than an NTN cell, for example, in terms of signalling delay and/or data throughput (e.g., an RRC resume procedure and/or data transfer may be subject to long propagation delay(s) in an NTN cell). The notification and/or delivery of a paging message may be subject to a latency (e.g., which may be long or longer than if a TN cell is used) in an NTN cell. An NTN cell may still be used for a paging message delivery (e.g., taking into account of a potential paging escalation, the delay may not always be worse on an NTN cell).

There may be differences between a RRC_INACTIVE state and a RRC_IDLE state (e.g., differences that result in challenge(s) compared to a RRC_IDLE state), for example, due to the WTRU being in CM-CONNECTED (e.g., connected to the core network). A base station (e.g., the last serving base station such as a gNB) may keep the WTRU context and/or the WTRU-associated connection(s) (e.g., WTRU-associated NG connection(s) with the serving AMF and/or UPF). Paging (e.g., RAN paging) may be initiated. For example, if the last serving gNB receives DL data from the UPF or receives DL WTRU-associated signaling from the AMF (e.g., if the last serving gNB receives the DL data or the DL WTRU-associated signaling, except the WTRU context release command message) while the WTRU is in an RRC INACTIVE state, the last serving gNB may page in one or more of the cells corresponding to a RNA and/or may send XnAP RAN paging to neighbor gNB(s) (e.g., if the RNA includes cells of neighbor gNB(s), the last serving gNB may page in those cells of neighbor gNB(s) as well).

If a WTRU camps on an NTN cell but has moved (e.g., such that the RNA of the TN may be changed), the DL data may have already been delivered to the last serving base station (e.g., a gNB in a TN cell) and, in some examples, if the WTRU is paged via the NTN cell, the WTRU may not be reached and/or may not be delivered the data in a gNB (e.g., any gNB) within the RNA, for example, unless the NTN gNB may be part of the same RNA as the last connected TN gNB, (e.g., which may or may not be likely due to the relatively large size of the NTN cell). Although one or more examples herein may use the term gNB, they may be applicable to any base station. The coverage of an NTN cell may cover multiple TN RNAs. The NTN cell in one or more examples herein may be interchangeably referred to as an NTN satellite.

In some examples, if the WTRU performs a RNAU to the RNA of an NTN cell and/or remain in an RRC_INACTIVE state, the data delivery on the NTN cell may be subject to a long latency (e.g., due to long propagation times on the NTN radio link).

Overlapping network layers (e.g., an overlapping TN-NTN coverage) may be used, for example, to achieve power saving and/or paging load benefits of an NTN cell if the WTRU is in an RRC_INACTIVE state (e.g., when the WTRU is in a TN and/or an NTN) and/or may be used to deliver data through a TN cell, for example, to achieve a better throughput and/or latency.

In examples, a WTRU, which is in an RRC_INACTIVE state (e.g., while the WTRU camps on a TN cell and/or is registered to a TN RNA), may be released to an RRC_IDLE state to perform a cell reselection to an NTN cell (e.g., to save power). The WTRU may be paged by the CN (e.g., only by the CN), and a different RRC connection (e.g., a new RRC connection) may be established on the NTN cell or may be established when the WTRU returns to the TN cell, for example, based on a redirection command or handover command from the NTN cell or based on an indication, in a paging message, to respond on the TN cell. The WTRU may save power by camping on an NTN cell (e.g., the WTRU, by camping on the NTN cell, may not always benefit from the latency advantage that can be had by being in an RRC_INACTIVE state). The example herein may be applicable to device(s) for which power saving is valuable (e.g., the devices that may require the latency advantage of an RRC_INACTIVE state in some instances or times and may require power saving in other instances or times). In examples, the devices may include wearable device(s) or portable device(s) which, at some instances or times, may be in use and may be in a standby mode in other instances or times.

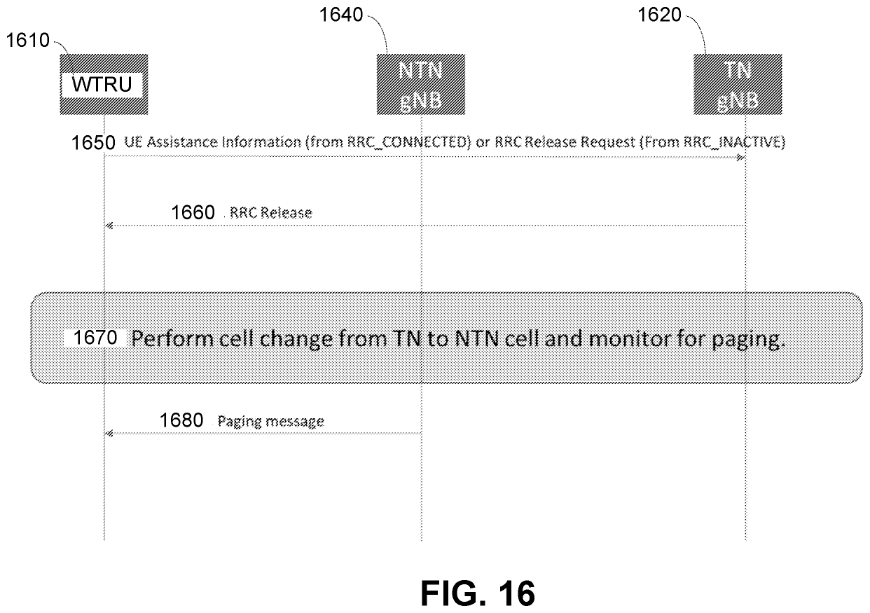

FIG. 16 is an example of release to RRC_IDLE for camping on an NTN. A WTRU (e.g., a WTRU 1610) may, at 1650, send WTRU assistance information (e.g., UE assistance information) or a RRC release request, for example, to a base station (e.g., TN gNB 1620).

The WTRU may send the WTRU assistance information (e.g., for the WTRU to be released to idle to camp on an NTN cell). In examples, the WTRU (e.g., the WTRU in an RRC_CONNECTED state) may initiate a transmission of the WTRU assistance information including, for example, an indication that the WTRU prefers to camp on an NTN cell (e.g., to save power). In some examples, the WTRU (e.g., the WTRU in an RRC_INACTIVE state) may first perform an RRC connection resume procedure, for example, to transmit the WTRU assistance information.

The WTRU may send the RRC release request (e.g., for the WTRU to be released to idle to camp on an NTN cell). In some examples, sending the RRC release request to move from an RRC_INACTIVE state to an RRC_IDLE state may be more efficient than, for example, sending the WTRU assistance information. The WTRU may transmit a message (e.g., Msg3, Msg5 or MsgA) or a request, for example when the WTRU is in an RRC_INACTIVE state. The message may include the RRC release request (e.g., the Msg3, Msg5 or MsgA may contain a new RRC message such as an RRC release request). The RRC release request may indicate or include an indication to indicate that the WTRU prefers to camp on an NTN cell.

The RRC release request or the WTRU assistance information may indicate or include an indication of the availability of the NTN cell. The WTRU may include, for example, in the RRC release request or the WTRU assistance information, one or more of: available measurement results of NTN cell(s) (e.g., measured via TN); location information (e.g. a coarse WTRU location); an indication (e.g., 1 bit) of a detected NTN cell that may be suitable (e.g., any detected NTN cell associated with a measurement above a threshold or any detected NTN cell that meets suitability criterion/criteria or condition(s)); information regarding satellite(s) and/or NTN cell(s) (e.g., including one or more of satellite ephemeris data, NTN deployment scenario(s), NTN cell reference point(s), satellite footprint information, neighbouring satellite assistance information, detected NTN cell ID(s)); information regarding time/frequency pre-compensation to the NTN cell (e.g. the WTRU's timing advance via a timing advance MAC CE).

In response to receiving the RRC release request or the WTRU assistance information, a network (e.g., a TN gNB 1620), at 1660, may transmit a message that indicates a change from the RRC_INACTIVE state to the RRC_IDLE state, for example, a RRC release message. The RRC release message may include cell reselection priority information (e.g., transmission priority information). The cell reselection priority information may indicate a priority associated with one or more frequency layers associated with NTN (e.g., the cell reselection priority information may indicate a higher priority assigned to NTN frequency layer(s)). The RRC release message may include a de-prioritization indication (e.g., a de-prioritization indication that indicates a de-prioritization for the current frequency layer or RAT such that the current frequency layer or RAT may be considered a lower priority than other frequency layer(s) or RAT(s). The RRC release message may include information indicating one or more of the following, which the WTRU may use to perform a redirection (e.g., the WTRU may attempt to camp on): a specific target frequency; a specific target band; a specific target cell; a specific target network. The information provided in the RRC release message may include a time value (e.g., a timer value during which one or more parameters apply; for example, the parameters may include parameters in the RRC release such as a cell reselection priority validity timer and/or a de-prioritization timer). For example, the information provided in the RRC release message may include a timer that specifies for how long the WTRU may camp/prioritise NTN frequency layers before resetting to use the broadcast priority value(s).

At 1670, the WTRU may perform a reselection to NTN (e.g., a cell reselection an NTN cell with NTN gNB 1640), for example, based on the information provided in the RRC release message. The WTRU may monitor for paging in the NTN (e.g., monitor for a paging message from the NTN cell with NTN gNB 1640). At 1680, the WTRU may receive a paging message from NTN (e.g., from the NTN gNB 1640).

In examples, a WTRU may perform a reselection to an NTN cell and remain in an RRC_INACTIVE state. In this case, a request (e.g., the RRC release request or WTRU assistance information described in one or more examples herein such as the example shown in FIG. 16) may be used to request a change of a network (e.g., a change from a TN to an NTN or a change from an NTN to a TN). In examples, a WTRU may, before a change from a RRC_CONNECTED state to a RRC_INACTIVE state, perform measurement(s) associated with one or more NTN cells and may send, based on the measurement(s), a request for a cell reselection to the NTN cell. The WTRU may receive an indication to change from a TN cell to the NTN cell after the request is sent.

The WTRU may receive a suspension indication (e.g., SuspendConfig) with the indication to change from the TN cell to the NTN cell, for example, after the request is sent. In examples, configuration information (e.g., configuration information associated with the RRC release) may include a SuspendConfig, for example, instead of information indicating a release to an RRC_IDLE state. In some examples, the WTRU may be configured to perform a reselection to an NTN cell (e.g., during the RRC connection and before the connection may be suspended), and/or maintain RNA tracking on TN while camping on the NTN cell, for example, as described in one or more examples herein.

TN-NTN interworking may be used. TN-NTN interworking may provide and/or enable one or more of the following: paging a WTRU (e.g., by an NTN platform) via an NTN cell; responding on or being redirected to a TN cell (e.g., so that the WTRU may remain in CM-CONNECTED, and DL data received at the last used TN base station (e.g., a gNB) may be delivered to the WTRU via the TN cell).

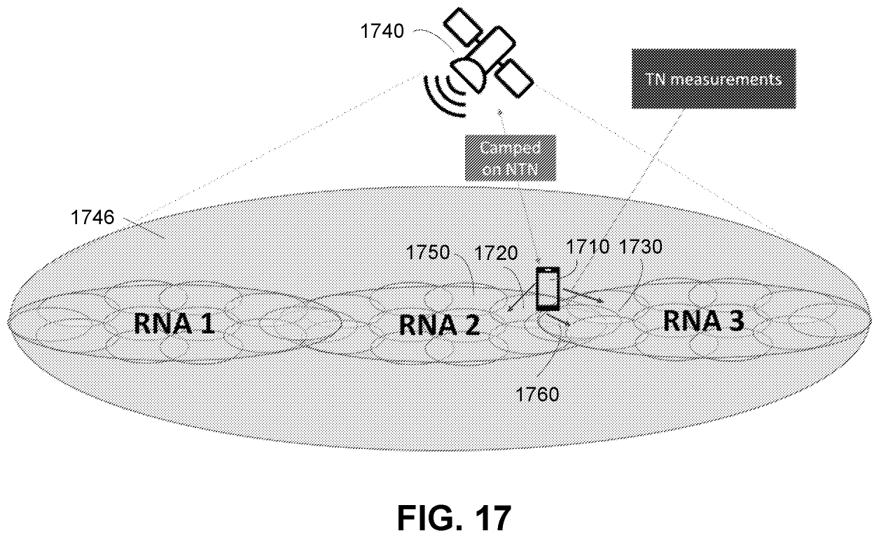

FIG. 17 is an example of a RNA change based on TN measurements. In FIG. 17, a WTRU 1710 may determine whether to perform a RNA update (e.g., a RNA maintenance) of a TN while the WTRU 1710 camps on NTN.

A RNA may include multiple cells. As shown in FIG. 17, RNA 2 may include multiple cells including cell 1750 and cell 1720. Cell 1750 and cell 1720 may be TN cells. A WTRU 1710 may be in an area where cell 1720, cell 1730, and cell 1760 have coverage, as shown in FIG. 17. Cell 1720 may be associated with RNA 2. Cell 1730 may be associated with RNA 3. Cell 1760 may be associated with RNA 3. The WTRU may perform cell measurements for cell selection or reselection.

For example, the WTRU 1710 may initially select cell 1730 associated with RNA 3. The WTRU 1710 may perform a cell reselection to an NTN cell 1746, for example, as shown in one or more examples herein. The WTRU may camp on the NTN cell 1746 (e.g., monitor for paging from NTN platform 1740 using the NTN cell 1746, etc.). For example, the WTRU may receive an indication to change from TN (e.g., the cell 1730 associated with RNA 3) to NTN (e.g., the NTN cell 1746). The WTRU may perform the cell reselection to the NTN cell 1746 based on the received indication. The WTRU may, for example, jointly with or separately from the indication to change from TN cell to NTN, receive an indication to change from an RRC_CONNECTED state to an RRC_INACTIVE state. The WTRU may be released to an RRC_INACTIVE state while it camps on the NTN cell. The WTRU may perform measurements, for example, to determine whether a cell reselection is to be performed. The measurements may be associated with different cells and/or RNAs. As shown in FIG. 17, the WTRU may perform TN measurements, for example, while the WTRU camps on the NTN cell 1746. The WTRU 1710 may evaluate one or more TN cells, for example, based on the TN measurements. The WTRU 1710 may perform a measurement associated with RNA 2 (e.g., a measurement of the cell 1720 associated with RNA 2 and a measurement associated with RNA 3 (e.g., a measurement of the cell 1730 associated with RNA 3 and/or a measurement of the cell 1760 associated with RNA 3), for example, while the WTRU camps on the NTN cell 1746. The WTRU 1710 may determine that a cell reselection condition has been satisfied (e.g., the cell reselection condition has been met or fulfilled). The cell reselection condition may be a TN cell reselection condition. The cell reselection condition may be associated with the cell 1720 associated with RNA 2. For example, the WTRU 1710 may move to a location that is better covered by RNA 2 than RNA 3, and/or a measurement associated with the cell 1720 associated with RNA 2 may be greater than a predetermined value. The WTRU 1710 may perform a cell reselection to the cell 1720 associated with RNA 2.

A WTRU may register with one or more RNAs. In examples, a WTRU may register with at least 2 RNAs (e.g., a first RNA associated with TN and a second RNA associated with NTN). In some examples, the WTRU may register to use the first RNA associated with TN and the second RNA associated with NTN. The WTRU may be registered with the first RNA associated with TN and the second RNA associated with NTN (e.g., simultaneously) before the WTRU performs a cell reselection to an NTN cell and/or transitions from an RRC_CONNECTED state to an RRC_INACTIVE state.

In some examples, a first RNA associated with TN and an NTN cell, or the first RNA associated with TN and a second RNA associated with NTN may be associated. This way, a WTRU may be paged (e.g., by receiving a paging message) via the NTN cell associated with the first RNA, and/or the WTRU may respond to the paging (e.g., in response to the reception of the paging message) via a TN cell associated with the first RNA. For example, the network may associate a TN RNA with an NTN cell (or with an NTN RNA) such that when DL data arrives at the TN gNB which was last used by the WTRU, the network may page the WTRU via the NTN cell in order for the WTRU to respond via a TN cell (e.g., the TN cell associated with the TN RNA). From a CN perspective, the WTRU may be in a TN cell (e.g., even though the WTRU is paged via the NTN cell). A TN base station may notify an NTN cell (e.g., the NTN cell associated with the TN cell) if the TN base station has data to be sent to a WTRU. For example, upon data arrival, the TN gNB may notify the associated NTN gNB, for example, via X2/Xn. The WTRU may be paged (e.g., “RAN” paged) in an NTN RNA or an NTN cell. The WTRU may respond (e.g., based on the reception of a paging message) in the TN cell.

A WTRU may measure and/or evaluate one or more TN cells, for example, for a cell reselection. The measurement(s) and/or evaluation(s) of the one or more TN cells may be performed when the WTRU camps on an NTN cell, for example, after a cell reselection of the NTN cell has been performed. The WTRU may determine that a cell reselection condition (e.g., a cell reselection criterion for a TN cell) has been satisfied. For example, a RNA change in TN may be performed based on the measurement(s) and/or evaluation(s) of the one or more TN cells. In examples, while a WTRU camps on an NTN cell, the WTRU may measure and/or evaluate the cell reselection criteria associated with a TN, for example, so that one or more suitable base stations (e.g., the correct gNB or a gNB within the TN RNA where the WTRU may be geographically located) are used to receive data from the WTRU and/or send data to the WTRU.

The WTRU may receive identification information associated with one or more RNAs (e.g., TN RNAs). The WTRU may receive cell identification information associated with a RNA. For example, the WTRU may receive a list of cell identities belonging to a TN RNA, a list of cell identities belonging to multiple TN RNAs, or multiple lists of cell identities belonging to multiple TN RNAs (e.g., a respective list of cell identifies for each of TN RNAs).

The WTRU may receive information on a cell reselection condition associated with a TN cell associated with a RNA, a cell reselection condition associated with a TN cell associated with a RNA, or a cell reselection condition associated with a TN cell associated with multiple RNAs. For example, the WTRU may receive cell reselection criteria corresponding to the cells. In examples, the cell reselection criteria may include threshold(s) and/or priorit(ies) related to cells on a frequency, for example, some or all cells on a frequency. A cell reselection condition may include a cell reselection threshold (e.g., a predetermined cell measurement value). A cell reselection condition may include cell reselection priority information (e.g., a predetermined priority level associated with a cell or a frequency). In examples, the cell reselection criteria may include cell specific information for a (e.g., each) respective cell.

Identification information associated with one or more RNAs and/or cells may be received, for example, via RRC signaling. One or more cell reselection conditions may be received, for example, via RRC signaling. Identification information associated with one or more RNAs and/or cells may be received in TN or NTN. One or more cell reselection conditions may be received in TN or NTN. In examples, the list of cell identities associated with (e.g., belonging to) one or more TN RNAs and/or cell reselection criteria (e.g., cell reselection thresholds and/or priorities) corresponding to the cells may be received in broadcast signalling or dedicated signalling (e.g., dedicated RRC signalling). The list of cell identities associated with one or more TN RNAs and/or cell reselection criteria corresponding to the cells may be received via a TN cell or via an NTN cell. In some examples, the list of cell identities associated with one or more TN RNAs and/or cell reselection criteria corresponding to the cells may be received via the broadcast system information from the TN cell(s) and/or be stored.

A WTRU may evaluate one or more cells of a first network, for example, while the WTRU camps on a second network. The WTRU may evaluate a virtual cell reselection status of the first network. For example, the WTRU may evaluate a cell reselection status of the first network, as if it camps on the first network, when the WTRU camps on the second network. For example, the WTRU may determine a virtual cell reselection status of TN, while camped on an NTN cell, based on one or more of: TN cell reselection information (e.g., the stored TN cell reselection information); RNA and/or cell information; measurement results. The TN cell reselection information may include, for example, a cell reselection condition. The RNA and/or cell information may include, for example, identification information associated with one or more RNAs and/or cells. The WTRU may perform one or more of the following as if the WTRU is camped on a TN cell (e.g., even though the WTRU may be camped on an NTN cell): measurements of one or more TN cells; evaluation of the cell reselection criteria of the TN cells; determination of whether a cell reselection to one or more of the TN cells is to be performed.

The WTRU may not perform a cell reselection (e.g., any cell reselection), for example, if a RNA associated with the WTRU does not change. In some examples, the WTRU may evaluate the cell reselection criteria without triggering a cell reselection (e.g., the WTRU may only evaluate the cell reselection criteria).

If a WTRU determines that a cell reselection to a TN cell may result in a change of RNA, the WTRU may notify a based station (e.g., the NTN gNB) of the change of RNA (e.g., a message indicating “RNA change in TN”). The WTRU may send the base station an indication of a change from a first RNA to a second RNA. The WTRU may be released to an RRC_IDLE state (e.g., before or without the cell reselection to a TN cell associated a different RNA). The base station may send the WTRU an indication to change from an RRC_INACTIVE state to an RRC_IDLE state, for example, in response to the indication of a RNA change that was sent by the WTRU. The WTRU may receive the indication to change from an RRC_INACTIVE state to an RRC_IDLE state, for example, from the base station. In some examples, when the WTRU operates in the RRC_IDLE state, the DL data may no longer be delivered to the WTRU in TN (e.g., since the WTRU may be no longer in the same RNA).

In examples, if the WTRU determines that a cell reselection to a TN cell may result in a change of RNA, the WTRU may initiate and/or perform a RNA update, for example, via NTN. In examples, the WTRU may initiate a RNA update procedure (e.g., the RNA update procedure as described in one or more examples herein), performing signalling via an NTN cell.

In some examples, if the WTRU determines that a cell reselection to a TN cell may result in a change of RNA, the WTRU may perform the cell reselection to a cell associated with a different RNA. In examples, the WTRU may initiate a cell reselection to the TN cell associated with the different RNA and/or trigger a RNA update on TN itself. The WTRU may return to camping on NTN again, for example, after the WTRU receives a data transmission from the TN cell associated with the different RNA.

Using one or more examples herein, a WTRU may camp on an NTN cell to avoid cell reselection(s) within a TN RNA and/or may perform a cell reselection (e.g., only perform a cell reselection when necessary) to update the TN RNA if the TN RNA changes. If a service is to be initiated, the WTRU may be paged (e.g., by receiving a paging message) on an NTN cell and/or respond, to the paging, via a TN cell. One or more examples herein may enjoy the power saving benefits of reduced cell reselection (e.g., the benefit of camping on NTN) and the benefit of an improved latency (e.g., a shortened latency by performing data delivery and/or the majority of signalling on a TN cell).

Some measurement conditions may be used, for example, for the measurements on TN while camped on NTN. In examples, if NTN is associated with a higher priority frequency layer than TN, and a NTN cell is of a suitable quality, the WTRU may not need to perform measurements on TN cell(s). In some examples, even if the NTN is associated with a higher priority frequency layer than the TN, and the NTN cell is of a suitable quality, the WTRU may perform measurements on one or more TN cells (e.g., a TN cell that is associated with a lower priority than the NTN cell). As an example, a condition may be to perform measurements of one or more TN cells or carriers according to the higher priority frequency requirements (e.g., the higher priority frequency requirements associated with the NTN) even if the TN cells or carriers are assigned a lower priority. The WTRU may perform measurements at a certain rate (e.g., a rate that is higher than high priority frequency measurements and lower than coverage-based measurements such as the requirements that apply when the coverage of the serving cell is below a threshold).

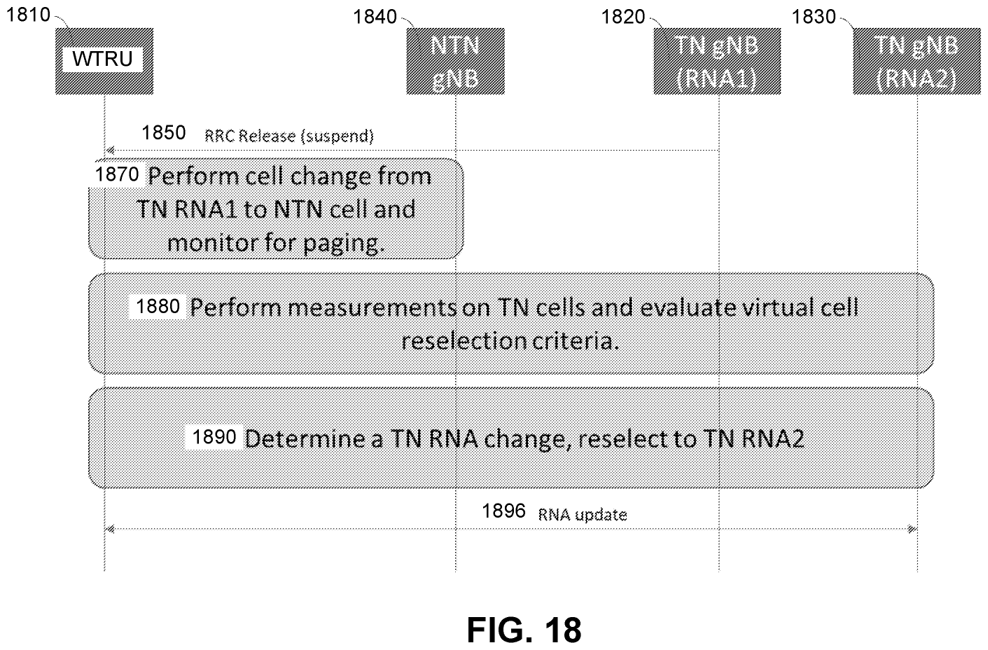

FIG. 18 is an example of a RNA change based on TN measurements. In FIG. 18, a WTRU 1810 may determine whether to perform a RNA update (e.g., a RNA maintenance) of a TN while the WTRU 1810 camps on NTN. At 1850, the WTRU 1810 may be released to an RRC_INACTIVE state with an indication to move to NTN (e.g., to an NTN gNB 1840). A network (e.g., a TN gNB 1820), at 1850, may transmit a message that indicates a change to the RRC_INACTIVE state (e.g., an indication associated with RRC release such as a suspend indication). The WTRU 1810 may receive the indication to change to the RRC_INACTIVE state. The WTRU 1810 may initiate the change to the RRC_INACTIVE state (e.g., a change from an RRC_CONNECTED state to the RRC_INACTIVE state), for example, based on the indication to change to the RRC_INACTIVE state.

The message may include the indication to move to NTN. The WTRU may initially select (e.g., perform a cell selection to) a TN cell associated with RNA 1, for example, the TN gNB 1820. The indication to move to NTN may include an indication to change from a TN cell to an NTN cell. For example, the WTRU may send, for example, to the TN gNB 1820, a request to change from the TN cell to the NTN cell. The TN gNB 1820 may send the WTRU 1810 the indication to change from the TN cell to the NTN cell, in response to the request.

In examples, the WTRU 1810 may receive separate indications (e.g., a first indication that indicates the change from the TN cell to the NTN cell and a second indication that indicates a change from an RRC_CONNECTED state to an RRC_INACTIVE state) at different times. The WTRU 1810 may receive the separate indications at the same time. The WTRU 1810 may receive an indication that indicates the change from the TN cell to the NTN cell and indicates a change from an RRC_CONNECTED state to an RRC_INACTIVE state. In some examples, the indication to change to a RRC_INACTIVE state may be used as an indication to change from the TN cell to the NTN cell. For example, the WTRU 1810 may initiate the change from the TN cell to the NTN cell based on a reception of the indication to change to a RRC_INACTIVE state.

At 1870, the WTRU 1810 may perform a cell reselection to an NTN cell (e.g., the NTN gNB 1840) and/or monitor for paging on the NTN cell. The WTRU 1810 may perform a cell reselection to the NTN cell, for example, based on the indication that indicates the change from the TN cell to the NTN cell. The WTRU 1810 may monitor for a paging message on the NTN cell, for example, after the WTRU 1810 performs the cell reselection to the NTN cell.

The WTRU 1810 may receive a paging message from the NTN cell, for example, when the WTRU operates in the RRC_INACTIVE state. The WTRU 1810 may initiate a change from the RRC_INACTIVE state to the RRC_CONNECTED state based on the reception of the paging message. The WTRU 1810 may receive, in the RRC_CONNECTED state, a data transmission from the second TN cell.

At 1880, the WTRU 1810 may evaluate one or more cells, for example, during a time period associated with the WTRU 1810 being configured to monitor for the paging message from the NTN cell. For example, at 1880, the WTRU 1810 may perform measurements of TN cells in RNA1 and RNA2, which may include TN gNB 1820 associated with RNA 1 and TN gNB 1830 associated with RNA 2, while the WTRU 1810 monitors for the paging message from the NTN cell. The WTRU 1810 may evaluate one or more cells at a time before the WTRU 1810 receives the paging message from the NTN cell and after the WTRU 1810 performs the cell reselection to the NTN cell. The WTRU 1810 may stop monitoring paging, for example, after the WTRU 1810 receives the paging message from the NTN cell. The WTRU 1810 may resume monitoring paging in NTN when the WTRU 1810 performs a cell selection/reselection to an NTN cell, for example, after the WTRU 1810 receives a data transmission from the TN gNB 1830 associated with RNA 2.

The WTRU 1810 may determine a virtual cell reselection status of TN, for example, during a time period associated with the WTRU 1810 being configured to monitor for the paging message from the NTN cell. The determination of a virtual cell reselection status of TN may include an evaluation of the one or more TN cells and/or limiting the evaluation to the one or more TN cells. For example, the evaluation of the one or more TN cells may include an evaluation of TN gNB 1820 associated with RNA 1 and/or an evaluation of TN gNB 1830 associated with RNA 2 and may be limited to TN cells (e.g., TN cells only). In some examples, the WTRU 1810 may evaluate the cell reselection criteria without considering the current NTN cell (e.g., perform a virtual cell reselection as if the WTRU was camped on a TN cell).

At 1890, the WTRU 1810 may determine that a condition (e.g., a cell reselection condition which causes a cell reselection from a cell in RNA1 to a cell in RNA2) is met. The WTRU 1810 may determine that a cell reselection condition associated with the TN gNB 1830 is satisfied, for example, based on the evaluation of the one or more TN cells including the TN gNB 1830. For example, the WTRU 1810 may determine that the RSRP associated with the TN gNB 1830 is equal to or greater than a cell reselection threshold. The WTRU 1810 may determine that a cell reselection priority associated with the TN gNB 1830 is suitable based on cell reselection priority information (e.g., transmission priority information) received in a RRC message. The WTRU may perform the cell reselection to the TN gNB 1830 in RNA2 (e.g., the cell reselection from the NTN cell to the TN gNB 1830 in RNA2).

At 1896, the WTRU may initiate a RNA update procedure (e.g., a RNA update procedure from RNA1 to RNA2).

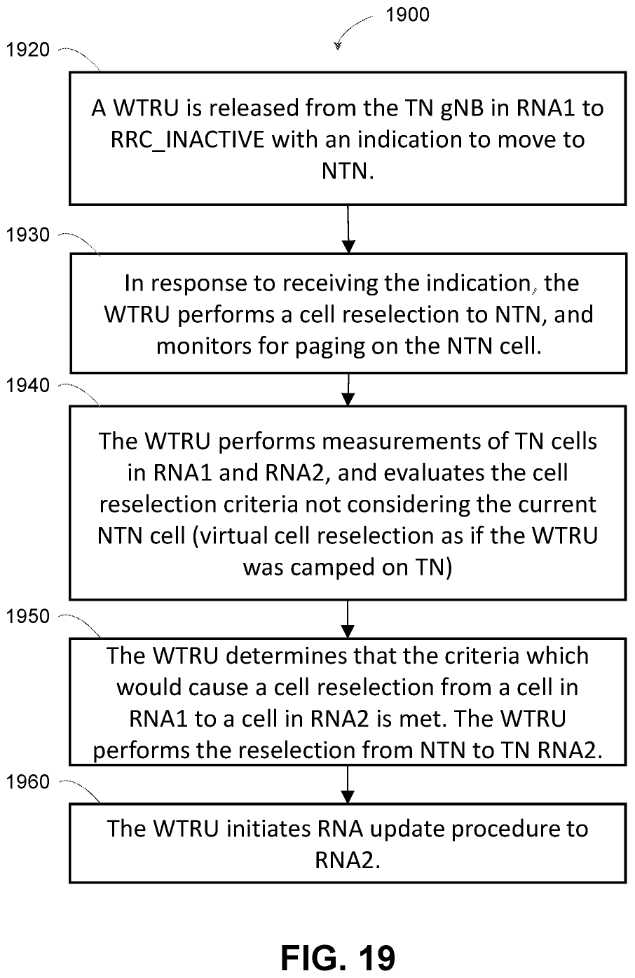

FIG. 19 illustrates an example 1900 for evaluation of one or more TN cells to determine a RNA update. At 1920, a WTRU may be released from a TN gNB in RNA1 to an RRC_INACTIVE state with an indication to move to NTN, for example, as shown at 1850 of FIG. 18. At 1930, the WTRU may perform a cell reselection to an NTN cell and may monitor for paging on the NTN cell, for example, as shown at 1870 of FIG. 18. At 1940, the WTRU may perform measurements of TN cells in RNA1 and RNA2 and may evaluate the cell reselection criteria not considering the current NTN cell (e.g., using a virtual cell reselection as if the WTRU was camped on TN), for example, as shown at 1880 of FIG. 18. At 1950, the WTRU may determine that the criteria which may cause a cell reselection from a cell in RNA1 to a cell in RNA2 is met, for example, as shown at 1890 of FIG. 18. The WTRU may perform a reselection from NTN to TN RNA2 (e.g., a cell reselection from the NTN cell to a TN cell associated with RNA 2), for example, as shown at 1890 of FIG. 18. At 1960, the WTRU may initiate a RNA update procedure to RNA2, for example, as shown at 1890 of FIG. 18.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to some or all types of service layer architectures, systems, and embodiments. The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read-only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer-executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that-in the case where there is more than one single medium-there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object-oriented programming language to communicate with a computer system. However, the program(s) can be implemented in assembly or machine language, if desired. In any case, the language may be a compiled or interpreted language and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing the preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

1. A wireless transmit/receive unit (WTRU), comprising:
a processor configured to:
receive an indication to change from a first terrestrial network (TN) cell to a non-terrestrial network (NTN) cell, wherein the first TN cell is associated with a first radio access network (RAN) based notification area (RNA);
perform, based on the indication, a cell reselection to the NTN cell;
determine that a cell reselection condition associated with a second TN cell is satisfied, wherein the second TN cell is associated with a second RNA; and
perform, based on the determination that the cell reselection condition is satisfied, a cell reselection to the second TN cell associated with the second RNA.

2. The WTRU of claim 1, wherein the processor is further configured to:
receive an indication to change a state of the WTRU from an RRC_CONNECTED state to an RRC_INACTIVE state;
initiate the change of the state of the WTRU from the RRC_CONNECTED state to the RRC_INACTIVE state; and
receive, during a time period associated with the WTRU being configured to operate in the RRC_INACTIVE state, a paging message from the NTN cell.

3. The WTRU of claim 2, wherein the processor is further configured to:
evaluate the second TN cell associated with the second RNA during a time period associated with the WTRU being configured to monitor for the paging message from the NTN cell, wherein the evaluation of the second TN cell comprises a measurement of the second TN cell and the determination that the cell reselection condition associated with the second TN cell is satisfied;
initiate a change of the state of the WTRU from the RRC_INACTIVE state to the RRC_CONNECTED state based on the reception of the paging message; and
receive, during a time period associated with the WTRU being configured to operate in the RRC_CONNECTED state, a data transmission from the second TN cell.

4. The WTRU of claim 2, wherein the processor is further configured to:
perform a measurement associated with the NTN cell; and,
before the change of the state of the WTRU from the RRC_CONNECTED state to the RRC_INACTIVE state, send, based on the measurement associated with the NTN cell, a request for the cell reselection to the NTN cell, wherein the indication to change from the first TN cell to the NTN cell is received after the request is sent.

5. The WTRU of claim 2, wherein the processor is further configured to:
receive identification information associated with a plurality of TN cells comprising the first TN cell associated with the first RNA and the second TN cell associated with the second RNA;
monitor for the paging message from the NTN cell; and
evaluate, based on the identification information, the plurality of TN cells during a time period associated with the WTRU being configured to monitor for the paging message from the NTN cell, wherein the evaluation of the plurality of TN cells is limited to the plurality of TN cells.

6. The WTRU of claim 1, wherein the processor is further configured to:
receive a cell reselection threshold in a radio resource control (RRC) message; and
determine a reference signal received power (RSRP) associated with the second TN cell associated with the second RNA, wherein the determination of the satisfaction of the cell reselection condition associated with the second TN cell comprises a determination that the RSRP associated with the second TN cell is equal to or greater than the cell reselection threshold.

7. The WTRU of claim 1, wherein the processor is further configured to:
receive, in a radio resource control (RRC) message, cell reselection priority information; and
determine a cell reselection priority associated with the second TN cell associated with the second RNA, wherein the determination of the satisfaction of the cell reselection condition associated with the second TN cell is based on the cell reselection priority associated with the second TN cell and the cell reselection priority information received in the RRC message.

8. The WTRU of claim 1, wherein the processor is further configured to:
send, to the NTN cell, an indication of a change from the first RNA to the second RNA;
receive an indication, from the NTN cell, to change a state of the WTRU from an RRC_INACTIVE state to an RRC_IDLE state; and
initiate, based on the indication, a change of the state of the WTRU from the RRC_INACTIVE state to the RRC_IDLE state before the cell reselection to the second TN cell is performed.

9. A method performed by a wireless transmit/receive unit (WTRU), comprising:
receiving an indication to change from a first terrestrial network (TN) cell to a non-terrestrial network (NTN) cell, wherein the first TN cell is associated with a first radio access network (RAN) based notification area (RNA);
performing, based on the indication, a cell reselection to the NTN cell;
determining that a cell reselection condition associated with a second TN cell is satisfied, wherein the second TN cell is associated with a second RNA; and
performing, based on the determination that the cell reselection condition is satisfied, a cell reselection to the second TN cell associated with the second RNA.

10. The method of claim 9, further comprising:
receiving an indication to change a state of the WTRU from an RRC_CONNECTED state to an RRC_INACTIVE state;
initiating the change of the state of the WTRU from the RRC_CONNECTED state to the RRC_INACTIVE state; and
receiving, during a time period associated with the WTRU being configured to operate in the RRC_INACTIVE state, a paging message from the NTN cell.

11. The method of claim 10, further comprising:
evaluating the second TN cell associated with the second RNA during a time period associated with the WTRU being configured to monitor for the paging message from the NTN cell, wherein the evaluation of the second TN cell comprises a measurement of the second TN cell and the determination that the cell reselection condition associated with the second TN cell is satisfied;
initiating a change of the state of the WTRU from the RRC_INACTIVE state to the RRC_CONNECTED state based on the reception of the paging message; and
receiving, during a time period associated with the WTRU being configured to operate in the RRC_CONNECTED state, a data transmission from the second TN cell.

12. The method of claim 10, further comprising:
performing a measurement associated with the NTN cell; and,
before the change of the state of the WTRU from the RRC_CONNECTED state to the RRC_INACTIVE state, sending, based on the measurement associated with the NTN cell, a request for the cell reselection to the NTN cell, wherein the indication to change from the first TN cell to the NTN cell is received after the request is sent.

13. The method of claim 9, further comprising:
receiving identification information associated with a plurality of TN cells comprising the first TN cell associated with the first RNA and the second TN cell associated with the second RNA;
monitoring for the paging message from the NTN cell; and
evaluating, based on the identification information, the plurality of TN cells during a time period associated with the WTRU being configured to monitor for the paging message from the NTN cell, wherein the evaluation of the plurality of TN cells is limited to the plurality of TN cells.

14. The method of claim 9, further comprising:
receiving a cell reselection threshold in a radio resource control (RRC) message; and
determining a reference signal received power (RSRP) associated with the second TN cell associated with the second RNA, wherein the determination of the satisfaction of the cell reselection condition associated with the second TN cell comprises a determination that the RSRP associated with the second TN cell is equal to or greater than the cell reselection threshold.

15. The method of claim 9, further comprising:
receiving, in a radio resource control (RRC) message, cell reselection priority information; and
determining a cell reselection priority associated with the second TN cell associated with the second RNA, wherein the determination of the satisfaction of the cell reselection condition associated with the second TN cell is based on the cell reselection priority associated with the second TN cell and the cell reselection priority information received in the RRC message.

16. The method of claim 9, further comprising:
sending, to the NTN cell, an indication of a change from the first RNA to the second RNA;
receiving an indication, from the NTN cell, to change a state of the WTRU from an RRC_INACTIVE state to an RRC_IDLE state; and
initiating, based on the indication, a change of the state of the WTRU from the RRC_INACTIVE state to the RRC_IDLE state before the cell reselection to the second TN cell is performed.

17. The WTRU of claim 1, wherein the indication to change from the first TN cell to the NTN cell is received in an RRC message.

18. The WTRU of claim 17, wherein RRC message comprises an RRC release message.

19. The method of claim 9, wherein the indication to change from the first TN cell to the NTN cell is received in an RRC message.

20. The method of claim 19, wherein RRC message comprises an RRC release message.
